(19) United States
(12) Patent Application Publication
(10) Pub. No.: US 2023/0306244 A1
(43) Pub. Date: Sep. 28, 2023

(54) Developmental Network Model of Conscious Learning in Biological Brains

(71) Applicant: GENISAMA LLC, Okemos, MI (US)

(72) Inventor: Juyang Weng, Okemos, MI (US)

(21) Appl. No.: 17/702,686

(22) Filed: Mar. 23, 2022

(51) Int. Cl. G06N 3/04; G06N 3/08

(52) U.S. Cl. CPC G06N 3/049; G06N 3/088

(57) ABSTRACT

How does a brain work? How does the brain learn? How does its consciousness arise? Is the consciousness required by learning? Holistic computational models for the four questions are still largely missing. Neural networks models are numerous, but they do not holistically address the four questions. Holistically and approximately addressing above four questions, the brain-developmental model here consists of a Developmental Network 3 (DN-3) that grows from a single cell and goes through prenatal and postnatal developments with a fully fluid architecture for any consciousness. The network becomes increasingly conscious through on-the-fly activities including brain-patterning—automatic inside a closed skull. The model provides a surprising insight into how consciousness is recursively necessary by brain's learning at each instant, called “Conscious Learning”. The biological model is computationally supported by our machine learning experiments in vision, audition, natural language understanding, and planning—all without a protocol flaw called Post-Selections.

### BACKGROUND OF THE INVENTION

Consciousness is defined [1] as (1) the state of being aware of a) something within oneself, b) external object state or fact, and c) social or political cause; (2) the state of being characterized by sensation, emotion, volition, and thought; (3) the totality of conscious state of an individual; (4) the normal state of conscious life; and (5) the upper level of mental life. It is hard to believe that a fruit fly does not have any of these. However, the consciousness in a mature fruit fly is different from, and probably not as rich as, that of an human adult. Because the present model is for all biological brains, from insects (like fruit flies) up to humans and is termed “Conscious Learning”.

For our discussion, we refer to consciousness as awareness for “larger and higher contexts”. With humans, such larger and higher context typically is often abstracted in a natural language. While executing daily routines, predicted concrete contexts are readily available from the brain network. Then, consciousness appears to be redundant but is important to safeguard against lower errors (e.g., forgot to bring your car key). In dealing with unfamiliar tasks (e.g., recover from a traffic accident), consciousness of “larger and higher context” seems to be critical.

Within each species, every brain's consciousness is very different but also shares a degree of similarity with other brains. For our model, we do not need to, should not, and must not discuss each of the five levels, since the model enables a brain network to autonomously bootstrap context complexity and brain's abstraction by uniformly treating all these 5 levels. We will only briefly discuss two examples at the end of Sec. V in Methods where it is appropriate to do so. I propose that the brain's motor is a port for expressing consciousness, enabling the brain to reach the richness typical for a species (e.g., intents, purposes, self awareness). For humans, natural languages (spoken, written, and signed) play a critical role for a brain network to reach all the levels (1) to (5).

Returning to the abstract, why do genomic programs appear to be task nonspecific? For example, my parents never used computers. Therefore, the genes from them that regulated the development of the brain of me—a computer science PhD—should not be specific to computer science tasks as well as other disciplines that I have learned and enabled me to discover the present model. Therefore, our developmental model of a species should not, and must not, model any specific tasks in the above levels (1) to (5).

The fundamental representational advances here are rooted in the discovery of emergent universal Turing machines for biological brains. An emergent (i.e., non-symbolic) universal Turing machine, learns not only data, but also any programs from its real physical environment [2] as a brain does. Namely, the “universal” property means such learned representations should cover all the five levels of consciousness—enabling incremental and simple-to-complex emergence of both consciousness and intelligence.

Is a fruit fly (Drosophila melanogaster) conscious? A fruit fly needs to forage, court mates, mate, and fight. It is known that a fruit fly learns quickly [3], [4] in its short life that spans only about 50 days. Without speaking a human term “consciousness” or reading a dictionary, a fruit fly probably will not be able to develop the concept of its own “consciousness”. However, the lack of human language does not mean that a fruit fly does not have five levels (1) to (5) which all arise through sensorimotor activities. Modeled here, all such activities of a fly also require consciousness. Human consciousness is obviously richer. In other words, if the model below has a sufficient set of Conscious Learning mechanisms, any individual should be able to develop the kind of consciousness that is characteristic of that species.

An animal brain consists of a huge number of neurons (from about 10⁵ for fruit flies [5] to around 10¹¹ for humans [6]) each of which receives and sends firing spikes and neural transmitters to one another. The holy grail question the present biological model has been discovered to answer is: From a single brain cell, how do more brain cells grow and work together without a central government, so that the entire brain gradually displays both consciousness and intelligence?

The Third World Science and Technology Development Forum (WSTDF) co-sponsored by UNESCO published “Top 10 Scientific Issues Concerning Human Social Development 2021” [7]. In the Information Field, the first issue is: “how does the human brain process information and how do humans form intelligence?” The present model provides a solution to the question, but also raises the necessity of formation of animal consciousness for the formation of animal intelligence.

Psychological studies have shown that consciousness appears to be involved in learning at various levels. At motivation level, consciousness about family expectation plays a role in how well girls learn mathematics [8]. At trust level, among children as young as 2 years old, reliance on consciousness of communicative cues supersedes firsthand experience [9]. At perceptual level, consciousness about object concepts is involved in perceptual learning, as shown by Xiao et al. 2008 [10] to be discussed below in Methods. Intuitively speaking, while you drive, your consciousness about the intents of potential obstacles and pending threats greatly changes your responses, from a traffic cone, to a pedestrian walking away, to a car running across your path, to a child running towards your car, to a person holding a handgun aiming at you. By conscious learning, we include all brain activates that give raise to consciousness, conscious and subconscious in traditional terms, not just those that a subject can explain verbally [11].

Many biological studies discovered mechanisms assuming other undiscovered mechanisms are in place. However, such mechanisms are piecemeal in nature, which are unlikely to solve the entire brain enigma. In contrast, a model about a biological brain, like an engineered system, must not miss essential mechanisms (see 20 “million-dollar” problems below). As raised by Marvin Minsky 1991 [12] and Michael Jordan 2014 [13], neural networks must solve some open problems (e.g., neural networks are scruffy-black boxes). The same problems are present for any biological models of the brain. The present biological model DN-3 holistically solves the following 20 “million-dollar” problems:
1) The image annotation problem: Unlike ImageNet [14], the retina is without a bounding box to mark something to learn. Solution: motor neurons automatically direct attention on retina.
2) The sensorimotor recurrence problem: Unlike “big data” [15], the next sensory input is altered by the current action. Solution: on-the-fly conscious learning in DN-3 avoids static “big data”.
3) The motor-supervision problem: Unlike motor-imposed learning, motors of a child are mostly free. Solution: motor-unsupervised learning in DN-3 as a biological norm.
4) The sensor calibration problem: Unlike camera calibration, a life must calibrate its eyes autonomously. Solution: the DN-3 calibrates all sensors through autonomous experience through trial and error.
5) The inverse kinematics problem: Unlike solving an engineering solution for redundant arms, a life must calibrate its limbs autonomously. Solution: a DN-3 calibrates all effectors via trial and error.
6) The government-free problem: Unlike a task-specific problem with a given goal, the brain is without an intelligent homunculus inside. Solution: each hidden neuron finds its own roles and competitors.
7) The closed-skull problem: Unlike a symbolic network, the skull is not open to allow an external teacher to supervise neurons' “gates”. Solution: hidden neurons in DN-3 all learn unsupervised.
8) The nonlinear controller problem: Unlike nonlinear controller with a given goal, the brain is without a given goal. Solution: DN-3 learns an open-ended list of tasks and sub-goals from the real world.
9) The curse of dimensionality problem: More global features may give a worse performance. Solution: DN-3 automatically emerges a hierarchy of features, from concrete (or local) to abstract (or global).
10) The under-sample problem. In a biological life, few sample events are available. Solution: DN-3 learns abstract events from one or few samples in motor space [16] and their transfers.
11) The distributed vs. local representations problem: In biology, both representations emerge. Solution: at a different motor context, each hidden neuron has a different meaning (see FIG. 2 later).
12) The symbol problem: Symbols do not ground the world automatically (the grounding problem) nor ground automatically across times (the frame problem). Solution: use (non-symbolic) vectors.
13) The local minima problem: Error-backprop learning [17], [18] gives very different performances for networks from different initial weights. Solution: Adaptive competitions avoid error-backprop.
14) The abstraction problem: Convolution is always location-specific and does not abstract [17], [18]. Solution: convolution-free Hebb-like representations bridging sensors and (abstract) motors [19].
15) The compositionality problem: A brain learns and applies implications beyond those composable from sentences [20]. Solution: DN-3 applies lifetime experience beyond sentence meanings [21].
16) The smooth representations problem: representations in a brain are globally smooth in 3D. Solution: in DN-3, the global smoothness is maintained from small to large [22], [23].
17) The motivation problem: A brain takes reinforcers and has various emotions [24], [25]. Solution: DN-3 bootstraps motivation through four classes of neural modulators: 5-HT, DA, ACH and NE.
18) The optimality problem: The brain learns incrementally but must avoid catastrophic memory loss [26]. Solution: a DN-3 is optimal in the sense of maximum likelihood [15] across lifetime.
19) The auto-programming for general purposes (APFGP) problem. A brain must learn to write a complex program for any practical purpose. Solution: DN-3 learns a universal Turing machine [21].
20) The brain-thinking problem. A brain conducts thinking like planning and discovery for any 3 practical purposes [27]. Solution: DN-3 conducts such thinking including planning and discovery [28].

Any of the above problems, if unsolved, would defeat a biological model of the brain. It is extremely challenging to address hidden representations in the brain. For example, Van Essen et al. [29], [30]proposed an interesting shifter circuit for location-based control (e.g., locational invariance-detect an object at any retinal locations) but their models did not explain how the shifter circuit is learned nor did they discuss invariance to other concepts (e.g., scale invariance—recognize an object of any scales). Our present model [31] learns invariances for any concepts as shown in FIG. 1—any concept must be invariant to all other concepts. Such a shifter-like circuit is learned, not handcrafted. The invariances are due to the top-down projections from the concept neurons in the later motor areas onto hidden feature neurons in the early perceptual areas. These top-down projections enable a kind of thinking called “off task process” by Solgi et al. [31], corresponding to the subjects' consciousness enabled thinking. However our model in Solgi et al. was not ready for general-purpose Conscious Learning till the present work. In cur present model, consciousness and invariance “auto-fill” each other during largely Subjective thinking, instead of pixel-to-pixel supervision (see evidence Xiao et al. [10] in Methods). Namely, thinking constructs consciousness and invariance altogether.

Therefore, biological experts should not object that a brain model is from a computer scientist by degrees who has learned other disciplines for over 40 years. The holistic solutions to the above 20 problems have traversed long mileage covered by biological mechanisms in earlier versions of DN discussed systematically in inventor's book [25] and simpler DN embodiments Where What Network 1 (WWN-1) [32] to WWN-9 [33]. Although the earlier versions of DN do not conduct conscious learning, they provide leg-work for DN-3 to solve the 20 “million-dollar” problems altogether. After DN-3 adds prenatal development from a single brain cell, naturally, conscious learning is discovered here to be necessary for any brain models. This necessity is a hidden holistic beauty of biology. Weng 2022 [34], [35] gave a Conscious Learning model and algorithm for machines but did not start with a single cell as DN-3 does here. A biological brain requires coarse-to-fine brain patterning from a single cell, which is new here, not present in DN-1 or DN-2. The present biological brain model with conscious learning seems to be the first ever for publication.

The most important discovery of the present work is the following “Conscious Learning Principle”:
Recursively through the lifetime of a biological life, at every instant, the existing consciousness of the life is necessary for the life to incrementally become a little more intelligent and conscious at the next instant. In biology, intelligence and consciousness go hand in hand through lifetime. Biologically inspired, trustable AI also needs consciousness.

For example, you must be conscious of your current intent (e.g., veer right) at the current instant so that you can become more conscious at the next instant about whether the current action makes you closer to your intent or farther. A fly seems to be conscious of a fly-equivalent of “am I doing well?”

### BRIEF SUMMARY OF THE INVENTION

Weng et al. 2001 [36] proposed that biological programs (i.e., functions of genes) that regulate autonomous mental development are task-nonspecific for a species, from a fruit fly [5], [37] to a human [38]. The programs first develop some basic innate behaviors that are necessary for bootstrapping later learning of an open array of tasks in each postnatal life. Consider four questions-how a brain works, how the brain learns, how its consciousness [1] arises, and how the consciousness is required by learning. Their answers are still largely enigmatic before this invention. Studies on biological consciousness are a very rich [39], [40], [41], [42], [43], yet holistic computational models for the four questions are still largely missing. Neural networks models are numerous, but they do not holistically address the four questions. Holistically and approximately addressing above four questions, the brain-developmental model here consists of a Developmental Network 3 (DN-3) that grows from a single cell and goes through prenatal and postnatal developments with a fully fluid architecture for any consciousness. The network becomes increasingly conscious through on-the-fly activities including brain-patterning [44]-automatic inside a closed skull. The model provides a surprising insight into how consciousness is recursively necessary by brain's learning at each instant, called “Conscious Learning”. The biological model is computationally supported by our computer experiments in vision [45, 0.78% errors], audition [46, 1.5% errors], natural language understanding [47, 0.02% errors when noise and signal are equally strong], and planning [28, 0.0% errors in new settings], all without a protocol flaw called Post-Selections [15] apparently rampant in AI. This biological model, along with some social implications, could be tested on animal brains. Conscious robots that will learn on the fly are waiting for the availability of brainoid Conscious Learning chips of brain scales.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic illustration of the Developmental Network Three (DN-3).

FIG. 3 is a piece of biological evidence about consciousness transfers learning.

FIG. 2 is a visualization, projected to 2D, of representations in a Developmental Network (DN).

FIG. 4 is a setting of autonomous imitation without motor imposition.

FIG. 5 is An example of a symbolic Turing machine that greatly facilitates our understanding the DN-3 model of a biological brain.

FIG. 6 is an abstraction in autonomous imitations of 1 demonstration (solid curves) and m−1 autonomous practices (dashed curves).

### DETAILED DESCRIPTION OF THE INVENTION

The following is a life-level algorithm on brain development, bypassing body co-development for simplicity. The DN-3 time-level algorithm is in Methods. This lifelong developmental model is alternative to existing studies of biological brains in terms of static features (e.g., edges [48] and places [49]) and machine learning that feeds pre-collected and annotated “big data” [17], [50], [51], [52], [53], [54].

Conscious Learning Algorithm (DN-3 Life-Level):
1) Inception: At the inception time t=0, initialize DN-3 network with only a single hidden cell.
2) Prenatal: For each indexed time t, repetitively run the DN-3 Time-Level Algorithm (see Methods) for prenatal development with motor-imposition (i.e., simulating functions of genome) to gain “innate” behaviors, where neurons may split; advance time t by one index in every network update. Thus, t can index any time frame in a real life, sampled at, e.g., 1 ms/frame, or 1000 Hz.
3) Birth due to body maturity, external reasons, or brain maturity.
4) Postnatal: For each indexed time t, repetitively run the DN-3 Time-Level Algorithm for postnatal development (i.e., autonomous imitations without motor-imposition) to gain “postnatal” consciousness and intelligence, where neurons may split; advance time t by one in every network update.
   An accidental or intentional death can occur any time.

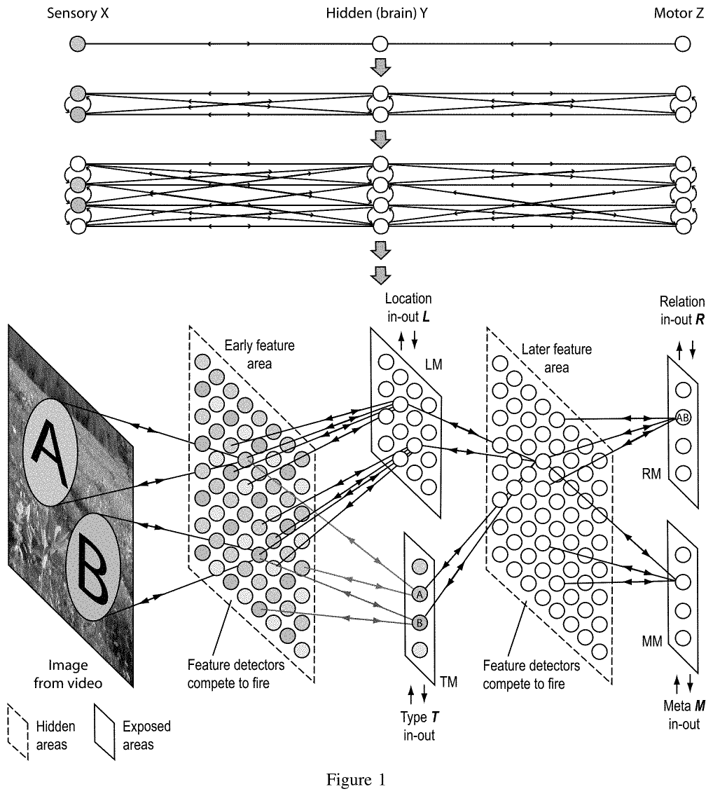

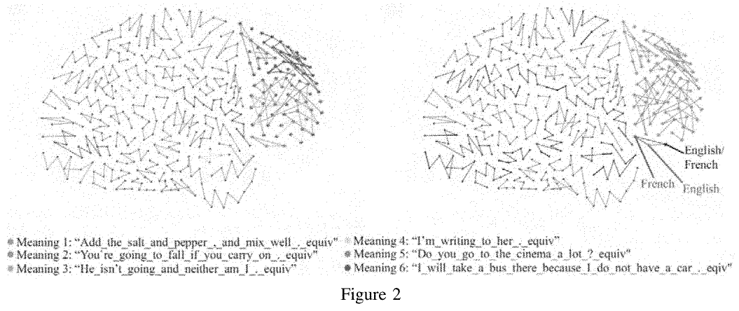

FIG. 1 gives a schematic illustration of the Developmental Network Three (DN-3), which has three areas, sensory X, hidden Y and motor Z. The DN-3 starts from a single cell in the Y area. Complex connections in the network are automatically patterned in a coarse-to-fine fashion. In conscious learning, the motor inputs are not needed but “in-out” is marked for completeness since “in” is network-emergent. The Y area is exploded Y=(Y_{early}, Yₗₐₜₑᵣ) and so is the Z area Z=(LM, TM, RM, MM). and how a conscious brain develops. The concepts marked include object location, object type, relation, and other meta concepts (e.g., culture and life concepts), all learned consciously from natural cluttered scenes that the learner consciously attends to and interacts with. The plasticity in later lifetime is important, but an innate brain is ready at birth.

Like a human baby, the algorithm does not require a precondition about what to learn. As long as the life lives in a natural 3D world, what to learn and how conscious and smart the network becomes depends on the following Four Learning Conditions:
1) the body (including sensors, effectors, and limbs),
2) the framework of the brain (e.g., incremental learning from a single brain cell),
3) the physical learning experience (including parents, peers, books, schools, and cultures), and
4) the limited computational resources (e.g. the numbers of neurons and connections). The algorithm does not specify static Brodmann areas [55] because the algorithm should automatically develop and adapt Brodmann areas if the body is human. If the body is a fly, the brain is for the fly.

Let us look at a visualization example of DN as a language learner. The number of neurons is sufficient so that forgetting does not take place. Suppose that a DN learns natural languages in a bilingual environment by taking a word at a time as sensory inputs. Each input word is represented as a numeric vector, as an English or French word, since we must avoid symbols as discussed above. While words arrive on the fly, a teacher supervises the network motor outputs, which has two concept zones, meaning of the current sentence and the language type. When the first word arrives, meaning is that of the single word. When the second word arrives, the meaning is that of the two words. Before the sentence is complete, the meaning is partial—from the first word to the current word—but the network is (partially) conscious. Hidden neurons in the brain are memories in the skull. Each hidden neuron, as a feature detector, has two inputs, bottom-up sensory input and top-down motor input (from the teacher), without input from the hidden area for simplicity. So, each hidden neuron has weights to match three parts: 1. bottom-up input (word), 2. top-down input (meaning from the beginning of a sentence) and 3. top-down input (language type). Thus, each neuron has two motor identities: meaning shown in the left part of FIG. 2 and language type shown in the right part of FIG. 2. FIG. 2 presents the distribution of neurons in a smooth brain-like map. The DN has learned in a bilingual environment. The Z motor area (right ⅕ region) has two concept zones (upper: meanings and lower: language types). The top-down connections from the Z motor neurons to hidden Y regions (left ⅘ region) cause each hidden neuron to have two concept attributes. Left panel: attention to meanings. Colors represent the meanings, thus transfer across languages (English and French). Right panel: attention to language type. Colors represent the language types, thus transfer across meanings (across many partial- and complete-sentence meanings). Figure adapted from [47]. The network has learned 2338 words and 8568 language contexts. The network recognizes state equivalence (e.g., “I do not” is equivalent to “I don't”). To test the robustness of the network in producing motor outputs, we inject random noise into the vector of each word. With signal to noise ratio (SNR) from 20 dB down to even 5 dB, the network produced no errors. When SNR is as low as 0 dB (i.e., the signal and noise have the same energy), the network made only 0.02% error. In reality, the number of meanings and language types is larger and the number of hidden neurons is not sufficient, causing feature clusters that forget some details. For conscious learning, the number of concept zones will be very large.

Visualizations for vision [45] and audition [56] are similar in principle. See [57] for multiple roles of hidden neurons in neuropsychologist studies.

Below, let us discuss methods.

### METHODS

The simplest architecture for pattern recognition by the hidden area Y is a cascade of feedforward subareas in Y [58], [59], [60]. From the sensory area X, the hidden area Y detects features that are concrete—of a particular retinal location, a particular feature type, a particular scale (retinal size), and a a particular orientation. The Y consists of a cascade of subareas where a later subarea takes inputs from the previous subarea so that it can detect larger features in the retina. This cascade avoids the difficulties of detecting a large-scale feature directly from the retina, since larger features deform greatly and are ˜ almost impossible to match well by a static pattern as argued in [60]. The firing neurons in the last subarea in the Y area link to the corresponding neurons in the motor Z where each neuron represents a class label. From WWN-1 [32] to WWN-9 [33], this feedforward and cascade architecture was extended to two-way (bottom-up and top-down) and two pathways (the ventral and dorsal pathways) [55]. The ventral pathway is connected to a motor subarea that represents feature types. The dorsal pathway is connected to a motor subarea that represents feature locations and scales. See FIG. 1. However, this two-way and two-pathway architecture is still too rigid for general consciousness, which seems to require to break all subareas and link any two neurons wherever needed. For example, see the Yₗₐₜₑᵣ in FIG. 1 which is important for consciousness. Freedom from government means that any rigid restriction on connections between any two feature neurons is bad for consciousness. If these two feature neurons are highly correlated or highly anti-correlated, should the brain catch that for consciousness? This leads to the consciousness required “brain connection rules” in Proposition 1 below.

The following biological mechanisms are critical for extending DN-2 to DN-3 so that general-purpose biological Conscious Learning can be finally modeled by DN-3. (1) Growth and patterning of a brain from a single cell. (2) In order for a newborn to learn autonomously from postnatal day 1, prenatal development using motor-imposed training to model biological development of innate behaviors. (3) Freedom from world-symbols anywhere in the brain, including motor areas, to enable motors to learn any world-consciousness (at levels 1 to 5) in any natural languages, spoken, written, and signed. (4) Usage-based neuronal mitosis (discussed below near Eq. (16)) to enable automatic recruitment of neuronal resources based on competition to model cross-modality biological plasticity [61]. (5) Freedom from motor-imposed training after birth so that postnatal learning is fully autonomous, like an animal. (6) Discovery of autonomous imitation as general-purpose for both learning consciousness and learning intelligence (e.g., like classroom learning). Of course, DN-3 is still a first approximation for the development of a biological and conscious brain and does not mean to exhaust all biological details of a species. The simulation results and performance evaluations of the predecessor DN-2 are available in [62], [63], [23], [56], [28].

More specifically, we must allow cells to connect automatically and figure out their role through a lifelong experience. Furthermore, our model must not limit the motor neurons to represent information in only a single time frame of the retina, but instead any concepts that a brain learns over space and time, including location, type, scale, orientation, 3D, speed, temporal context, spatiotemporal context, including levels 1 to 5 in consciousness. Moreover, our model must fully use such motor-contexts on the fly. Although not absolute, we expect motor neurons, as well as hidden neurons near the motor areas (e.g., premotor subarea and frontal subarea) are generally more abstract (i.e., less concrete) enabled by consciousness at that time. This is because motor neurons are generally more abstract (e.g., let your motor say the definition of levels 1 to 5 for consciousness). Therefore, consciousness and motor are often interchangeable since motors are abstract; but consciousness and sensor are often not interchangeable since sensors are concrete.

In particular, biological neurons do not use convolutions, because shift-invariance implied by convolution defeats (1) the location information required by many concepts along the dorsal pathway and (2) location-nonspecificity (features with partial locational invariance) in later subareas of the ventral pathway (i.e., Yₗₐₜₑᵣ in FIG. 1). In addition, a biological neuron does not quickly shift its receptive field either [6, p. 1019-1129].

In general, the Conscious Learning Algorithm approximates the functions of genome for the brain, not the genome itself. The algorithm regulates the development of a brain network called DN-3 that enhances DN-1 and DN-2 to become more biologically plausible and conscious-learning capable. A DN-3 has three areas, the sensory area X, the motor (effector) area Z and the hidden (brain) area Y. At the earliest time of the brain, the hidden area has only one cell (a positive-negative neuron pair where each neuron spawns sequentially). The same is true for the sensory area and the motor area. Then, all the three areas grow [64]. The nerve growth factor of DN-3 regulates the criteria for a cell to split (mitosis). The numbers of sensory cells and the motor cells grow according to the real time. The hidden cells grow according to the degree of match to its inputs (bottom-up, top-down and lateral) and how often they fire. All the three areas are limited by the available neuronal resources.

The DN-3 algorithm generates a computational and neuromorphic DN-3 network for conscious learning in postnatal autonomous imitations without 2D motor-impositions. The present biological model is applicable to both animals and robots.

We will see below that imitations are of general purpose for fully automatic development while the life interacts with its physical environment using the sensors and effectors on its body. There have been many models about imitation learning reviewed by [65] but they are all of special purposes, because they are not embedded with a capability of learning an emergent universal Turing machine and are therefore are task-specific (i.e., a human programmer designs a representation for a given task), too rigid for conscious learning. Furthermore, their learning of a finite machine is not error-free like a DN. In contrast, a DN-3 learns an open-ended simple-to-complex tasks directly from the real physical world, like a biological life, either a fly, a human, or any species in between.

Here is how imitations take place. The learner observes demonstrations by a 3D physical event, which may include human teachers such as in classroom teaching. It observes the 3D demonstration through the 2-D sensors (eyes, cochleae, etc.) and autonomously imitates the demonstrations by creating a 2D motor program. It executes the 2D motor program back onto the 3D world to generate 3D effects. Thus, we call this kind of autonomous, on the fly, end-to-end learning as 3D-to-2D-to-3D conscious learning.

The remaining more detailed material is organized as follows. Sec. I motivates us not to consider the brain as a mainly bottom-up recognizer. Sec. II outlines the requirements by lifelong development. Sec. III discusses the formulation of Conscious Learning. Then in Sec. IV, we present the DN-3 Algorithm. Sec. V presents autonomous imitation enabled by the DN-3 Algorithm. In Sec. VI, we analyze some important properties of the model. Finally, we conclude with some remarks in Sec. VII.

### I. CONSCIOUS EFFECTS OF TOP-DOWN PROJECTIONS

Let us consider an important piece of evidence in Xiao et al. 2008 [10] about how available consciousness generalizes on the fly during human perceptual learning-instead of using brute force image-annotations by teachers in our first million-dollar problem above. To be clear, we introduce categories of concepts as all-capital words (like TYPE) and a value of a concept category as lower-case words (e.g., TYPE=ctrst). Typically, perceptual learning of retinal features is found to be specific to the retinal feature concepts (i.e., expressed as motor-actions) (e.g., TYPE, LOCATION, and SCALE) because perceptual learning transfers little to an untrained retinal concept (when motor consciousness fails to attend to the concept or transfers did take place but were not measured). Must the brain learn abstraction from every concrete event (e.g., (TYPE=face) & (LOCATION=loc1)) by sensing all variations of the concept-value combination (e.g., (TYPE=face) & (LOCATION=loc2))? Many artificial neural networks seem to imply so (e.g., see [59], [60], [19]), which gave rise to the above image annotation problem.

The following evidence from Xiao et al. 2008 [10] seems to demonstrate that consciousness available at each instant automatically transfers by combining double (consecutive) concrete events (e.g., (TYPE=ctrst) & (LOCATION=loc1) followed by (TYPE=ori) & (LOCATION=loc2) is generalized on the fly to an unsensed event (TYPE=ctrst) & LOCATION=loc2). But an individual event (TYPE=ctrst) & (LOCATION=loc1) alone is not automatically generalized to the unsensed event (TYPE=ctrst) & LOCATION=loc2). According to the DN-3 model, the motor neuron (TYPE=ctrst) in the earlier event and the motor neuron LOCATION=loc2 in the later event are still firing (due to the time proximity between the two events) which leads to a transfer to (or imagination of) an unsensed event (TYPE=ctrst) & LOCATION=loc2) if the human brain does not predict so. The coupling of the two events forced all human subjects to predict the unsensed event (TYPE=ctrst) & LOCATION=loc2). In other words, if after (TYPE=ctrst) & (LOCATION=loc1), DN-3 subjectively predicts (TYPE=ctrst) & LOCATION=loc2), a similar transfer effect results! As an example of a recent war event, if Vladimir Putin heard (TYPE=nato) & (LOCATION=ukraine) and he predicts (TYPE=nato) & (LOCATION=russia), no need for its actual happening, he reacted accordingly. Predicted danger causes wars, because human brains are conscious. Consciousness self-generates concepts through predictions. In other words, consciousness enables intelligence. This seems to be true for all levels 1 to 5 in consciousness.

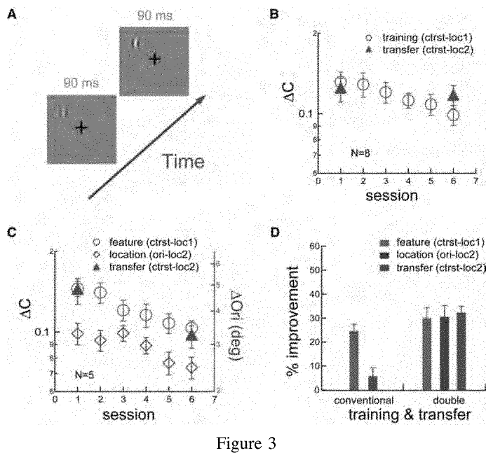

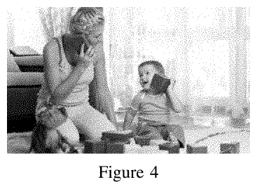

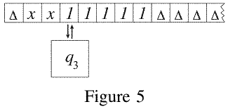

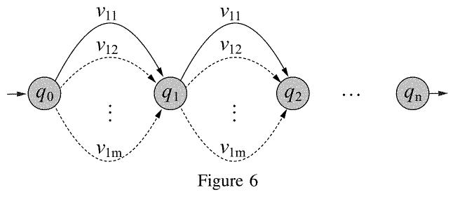

Xiao et al. 2008 [10] reported that in a double-task training paradigm, a complete transfer across two locations on retina (loc1 and loc2) took place, as shown in FIG. 3. Human subjects were taught in a double-task training experiment. In the first task, they saw stimuli in A (contrast at upper left loc1, called const-loc1) with performances as green in C across 6 sessions. In the second task, they see another stimuli (a different feature ori at lower left, called ori-loc2) with performances as blue in C also across 6 sessions. Each subject goes through 6 sessions ordered in time, 1 through 6, as shown in C, but only in sections 1 and 6, each subject also sees (primed) a transfer task (contrast feature at lower left, called ctrst-loc2, marked in red in C. In C, the gradually lowered positions of green and blue marks indicate gradual improvements over practice, which is expected. However, it is surprising that the transfer task (red) is also improved at session 6, although the transfer task (red) was not trained at all! The blue bar in D means the transfer is complete, as red bar is as high as the green bar in “double”. However, in B, the upper right event (a new loc2, can be marked as loc3) that was not thought did not enable a transfer (see “conventional” in D).

This was a consequence of subjects' consciousness that relates two consecutive tasks using top-down projections during the learning. However, such cross-task transfer did not take place to other un-thought retinal locations! Namely, learning intelligence requires “on the fly” consciousness.

Specifically, in the first task (ctrst-loc1), the subjects learned the first feature (ctrst) at upper left (loc1) followed immediately by learning a second task (ori-loc2) for a different feature (oni) at lower left (loc2). a But a new combination (ctrst-loc2) was also greatly improved. Our Conscious Learning brain model here explains that if and only if consciousness thinking of a motor concept (here, lctrst-loc2) occurs, transfers take place, and the event (ctrst-loc2) does not need to actually take place. These transfers are not only important for perceptual learning, but also in language-based consciousness. While reading a book the reader can use his own lifelong consciousness.

For comparison between the concepts here and our model, the meanings in FIG. 2 correspond to (ctrst) and (ori); the language types in FIG. 2 correspond to (loc1), (loc2) and (loc3).

Our work in Solgi et al. 2013 [31] used simulations to explain that, using the principle of WWN, any motor concepts that fire consecutively (e.g., ctrst-loc1 then ori-loc2) are transferred (e.g., as ctrst-loc2 reported while ori-loc1 not transferred) and they can represent virtually any concept, such as locations, feature types (e.g., face, object), scales, colors, lightings, meta concepts and so on. Cong Yu's group has extended their studies also the level of concepts [66]. Namely, conscious thinking takes place during learning and results in desirable transfers of learned concepts. Consciousness is critical to how a biological brain works-learns, thinks, transfers, all on the fly. Generalizations (invariances) do not need exhaustive stimuli. Pixel-by-pixel shifting in convolutions is for locations only, damaging for representations, and biologically implausible. Conscious thoughts are automatic, sufficient and general.

### II. REQUIREMENTS BY CONSCIOUS LEARNING

Human infants can hardly survive without intensive parent care. However, it is not true that they learn from a blank slate. Typically, the lower the animal species, the more innate behaviors are present in a newborn, i.e., developed prenatally. For example, spontaneous retinal signals (and motor signals) are required for wiring visual circuits before birth [67].

First described by zoologist Konrad Lorenz in the 1930s [68], imprinting occurs when a newly hatched animal (e.g., duckling) forms an attachment to the first moving thing it sees upon hatching. Experiments have shown that imprinting appears to be a quick-learning process-learning the appearance of the first moving object, which is usually the mother. However, this moving thing can also be a moving toy, a balloon, or even a stop sign. Imprinting in ducks only occurs during a critical period, starting from 3 hours after hatch, peaked at 15 hours and ends at about 30 hours. Effects of imprinting are lasting, firm, and visually precise.

Human infants do not present imprinting. However, human infants display some innate behaviors too, such as rooting, kicking, and sucking [38]. Infants from 16 to 21 days old imitate (a) tongue protrusion, (b) mouth opening, and (c) lip protrusion demonstrated by an adult [69].

Informed by biology, let us consider that a life has two alternatives for each of its effectors: (A) simple behaviors (such as crying)—behaviors that are learned in the prenatal environment (e.g., womb), (B) complex behaviors—behaviors that are so complex that their learning require postnatal environment (e.g., outside the womb) after the birth. Vocal effectors that make all possible human sounds, other than crying, especially those that require feedbacks (hear own voice) to learn, are examples of sophisticated behaviors. Wu & Weng [56] employed the Candid Covariance-free Incremental (CCI) Principle Component Analysis (PCA) to develop vocal effectors and speaking behaviors directly from hearing sounds and speaking sounds using DN-2.

Unlike human learning, existing machine learning capabilities are weak, restricted, and not autonomous. By weak, we mean that they mainly use motor-imposed mode or reinforcement mode. By restricted, we mean that they are not applicable to attention, especially language-based attention. By not autonomous, we mean what to learn and when they learn are not autonomously determined by the learner, but controlled by a human teacher. In short, the machines are unconscious, during and after the learning.

The present model goes beyond the current three modes of learning, motor-imposed, reinforcement (including classical conditioning and instrumental conditioning), and unsupervised (including non-associative learning). In fact, the internal mechanisms inside a DN are always unsupervised—skull-closed [6]. As we will see below, the new kind of learning—conscious learning by imitation allows more sophisticated learning subjects, such as sophisticated effectors and internal attention that currently machines do not have a way to be taught if their skulls are closed.

Thus, conscious learning by imitation is the first algorithmic theory, as far as the inventor is aware, to understand how biological brains incrementally gain intelligence and consciousness in parallel. Learning intelligence needs learning consciousness and vise versa.

The reader is encouraged to read [70] that discusses consciousness assuming simpler motor-imposed trainings, but motor-imposed training is rare in biology.

### A. Thirteen Conditions of Conscious Learning

FIG. 4 is a setting of conscious learning in a cluttered scene. Picture courtesy of proplep-parenting.com. Motivated by the figure, let us formally define 13 conditions of conscious learning in computational terms.

Definition 1 (Conscious learning conditions): Conscious learning satisfies 13 conditions below, short as two acronyms SACUT GENISAMA:
1) Single brain cells to start, sampled at appropriate time intervals—from a firing rate model (about 100 Hz) to a spiking network model (about 1 kHz).
2) All lives reported: Freedom from Post-Selections [15] that require many trained networks to “die” (i.e., whose performances not reported), except the luckiest, since almost all biological lives develop normally. Many published AI experiments suffer from the flaw of the Post-Selection protocol.
3) Contexts as motor-hidden-receptor triplelets: Each brain context has three components, motor, hidden and receptor. The transition of brain contexts is context-to-context at a time instead of receptor-to-motor at a time, where motor, hidden and receptor are all numeric vectors (free from symbols) to address the above symbol-grounding problem [71] and frame problem [72].
4) Unsupervised: the biologically plausible and dually optimal LCA (Lobe Component Analysis) [16] models for unsupervised neuronal learning, consistent with the Hebb's postulate [73], instead of error-backprop [74] which is “supervised” or value-backprop [75] which is “time-discount”.
5) Turing machines: learning any vectorized Turing machine, error free, as long as the number of neurons (equal to the finite number of transitions in the Turing machine) is sufficient. Namely, having solved not only the problem of abstraction raised by [12], [13] but also the problem of learning universal Turing machines [27] so as to learn rules and programs directly from the physical world.
6) Grounded: All neurons in the sensory area and motor area interact with the skull-external physical world as numerical vectors. No symbols are allowed in the firing patterns of a brain network, not even as motor labels, because symbols reside in human communications, not intrinsic in biology.
7) Emergent brain areas: All patterns in the sensory X, hidden Y and motor Z areas grow and emerge from activities. Each neuron's resources are also emergent, such as its competition zone.
8) Natural: All responses in a brain area are natural from real receptors and real muscles, without using any task-specific encoding. This includes foveated retina and non-uniform skill sensors.
9) Incremental: The brain network incrementally updates at discretely sampled times t=1, 2, . . . . Namely, the brain uses the triplelet context at time t−1 to update the brain which generates the next triplelet context at time t. This is because the sensorimotor recurrence principle—what the next image is depends on the current action. Avoid pre-collecting data (e.g., ImageNet and other “big data”).
10) Skull-closed: As the skull closes the brain from the environment, everything inside the hidden Y area (e.g., neurons and connections) are off limit to the external environment's direct manipulation from the inception time t=0.
11) Attentive: In every cluttered sensory image, in every cluttered motor image, and in every cluttered hidden image (map), only some attended parts correspond to the winning context. For example, the attention for a sensory image is applied to a projection from a cluttered 3D world, consistent with [76], [29], [30], different from that in [77], [78] which is applied to a structured internal memory.
12) Motivated: Different neural transmitters have different effects to different neurons, resulting in avoiding pains, seeking pleasures, speeding up learning of important events, estimating uncertainty and novelty, maintaining neuronal connections (synaptic maintenance for auto-wiring) and change behaviors (e.g., novelty seeking). Thus lower motivations scaffold higher motivations, emotions and the 5-level consciousness.
13) Abstractive: Each learned concept (e.g., object type) in motor Z are abstracted from concrete examples in a concrete context triplelet, invariant to other concepts learned in Z (e.g., type, location, scale, and orientation). E.g., the type concept “dog” is invariant to “location” on the retina (dogs are dogs regardless where they are). Invariance is different from correlation: dog-type and dog-location are correlated (e.g., dogs are typically on ground).

The biological Conscious Learning model here differs from many well-known neural networks, such as Convolutional Neural Networks (CNNs) [74], [59], [79], [80], [17], [78], [18] and Long Short Term Memories (LSTM) [81], swarm computing [82], reservoir computing, and evolutionary computing in most of the above conditions, especially condition 2.

### B. Eight Learning Modes

In traditional machine learning, there are only three modes of learning-supervised, reinforcement, and unsupervised. In biology, each effector has 23=8 modes.

Consider three logic bits (seb)-supervised internal representation, effector imposed, biased sensors used. We have a new definition of 8 learning modes called SEB learning modes:

Definition 2 (SEB learning modes): Let seb represent a binary number. s=1: skull-internal representation is human supervised, s=0 otherwise; e=1: effectors are imposed by a teacher, e=0 otherwise; b=1: biased sensors (pain, sweet, instead of unbiased sensors like cameras and microphones) are used; b=0 otherwise. Then, the seb binary codes have 8 patterns, seb=000, seb=001, . . . , seb=111.

Therefore, s=1 corresponds to symbolic representations-human crafted task-specific representations, such as Simultaneous Localization and Mapping (SLAM), Markov Decision Process (MDP), Partially Observable MDP, Graphical Models, as well as neural networks that have human handcrafted features such as human selected features and gates in CNN and LSTM. s=0 corresponds to DN and other inside-skull-unsupervised networks (e.g., reservoir computing that use random hidden neurons).

The case e=1 means a human teacher imposes effector for teaching purpose (motor-imposed).

Note that eb in seb has four binary patterns, eb=11 is a combination of supervised learning and reinforcement learning, which is not common in machine learning publications but allowed in biology since such a case may occur in biological learning (e.g., torture).

In the Conscious Learning model, we are interested in seb=000 during which imitations take place. seb=010 and seb=001 only occasionally occur like the setting in FIG. 4.

In biology, the credit assignment problem (i.e., which action attributes to an reinforcer—reward or punishment received) is an open problem. The time delay between the action and the reinforcer often is long (e.g., hardworking for a PhD degree). In the present model, the credit assignment problem is addressed by Conscious Learning—association between an action and an reinforcer via transfers as we discussed above (e.g., teaching by parents, culture, religion via consciousness), instead of the rigid value discounts in the Q-learning model [75].

There are additional limitations in current methodology of machine learning fed by static datasets: (1) The non-sensorimotor recursive nature of any datasets (no static datasets can approximate sensorimotor recurrence which is dynamic in nature). (2) Post-Selections [15] cherry-picking the luckiest network without cross-validation. (3) A lack of conscious learning, further explained below.

As shown in FIG. 4, the environment is cluttered containing complex objects. At any time, there might be many different items (e.g., the blocks and the parent in FIG. 4). Only some of them are related to the current task that needs to be attended to. Typically, a related object occupies only a small patch of a retinal image. Other objects in the retinal image are distractors. In a DN, hidden neurons that win to fire represent attention to their receptive fields.

In computer vision, the requirement of manual annotations of attended polygons [60], or a bounding box [14], in each input image is non-scalable to real-world deployments and implausible in biology.

A more promising way is to set a kid free into deployed physical settings, like that in FIG. 4, so a that the kid learns from his own actions including attention actions. It is worth noting that attention is not supervisable because it takes place in hidden neurons inside a closed skull. In conscious learning, attention is self-taught through a process of trial and error to be further explained below.

### III. FORMULATION OF BRAINS

Turing machines by Alan Turing [83] were not meant to model biology or to explain conscious learning. But they can assist us to understand a biological brain and how consciousness arises from computations.

A symbolic Turing machine [84], [85] illustrated in FIG. 5, consists of an infinite tape, a read-write head, and a controller. Each integer location of the tape bears only a single symbol. The controller is represented by a transition table, which at each integer time has a handcrafted state (e.g., q₃ here) that memorizes an abstract context. The look-up table is not shown. In contrast, in the DN-3 model, a biological brain emerges from a single cell-without any skull-internal symbols: The symbolic tape becomes the cluttered real world; the read-head extends to the real sensors of the body; the write-head is generalized into the real effectors of the body; and the handcrafted, symbolic, and static transition (look-up) table corresponds to the hidden brain that must automatically emerge, symbol-free, dynamic, and incrementally conscious. The DN-3 learns programs and data from the real world.

The controller of a Turing machine is a look-up table that consists of a sequence of transitions where each transition is in the following “five-word” form:

(q,γ)→(q′,γ′,d) (1)

meaning that if the current state is q and the current input sensed by the head from the tape is γ, then the machine enters to next state q′, writes γ′ onto the tape, and the head moves in direction d (left, right, or stay).

Weng [2] extended the state space Q={q} to a new form Q′={(q′, γ′, d)} which is important to understanding a brain. With Q′, he proved that the controller of any Turing machine is an agent Finite Automaton (FA), where the agent means that the FA outputs its states. It has been widely accepted that a Turing machine can simulate a procedure of pen-and-pencil. This assumption is called Church-Turing thesis that has been formally proven by Weng 2020 [21].

A universal Turing machine reads only any input tape that has two parts, a program and a data set (both artificially encoded). The program is a sequence of transitions in Eq. (1). The universal Turing machine is designed to emulate the input program on the input data and produces the output to the tape. Because the program can be any procedure in the Church-Turing thesis, it has been widely accepted that the universal Turing machine is a model for general-purpose computers, but using only symbols.

Weng [21] extended the tape to the 3D real world, the read-write head to sensors and effectors, and enabled the network to learn the transitions of such an extended universal Turing machines that is not symbolic, but in vector forms as explained below. The exclusive use of vector forms (as firing of multiple neurons) enables the network to emerge representations automatically from real-world sensors and effectors, bypassing any use of symbols. Symbols artificially code meanings that are only in the mind of the programmer but such meanings are not conscious to the network unlike natural vectors.

Let us review of maximum likelihood (ML). The probability of an event of observation c depends on a set of parameters v in the space V of all possible vectors, represented as a discrete probability ƒ(c; v). The ML-estimator of v computes the v that maximizes the probability of the observed event:

$${v}^{*} = {arg max}_{v ∈ V} f ( c ; v ) .$$

Since our brain computes incrementally, at each time t, we model that the brain computes the ML-estimator for vₜ (all parameters in the brain at time t) from the observed event (context) cₜ₋₁ (in the sensors, effectors and the brain at time t−1), by using the previously estimated ML-estimate v*ₜ₋₁:

$${v}_{t}^{*} = arg {max}_{{v}_{t} ∈ {V}_{t}} {f}_{t} ( {c}_{t - 1} ; {v}_{t - 1}^{*} , {v}_{t} ) , t = 1 , 2 , \qquad ( 2 )$$

The computation of the above function ƒₜ is our DN-3 algorithm, which does not need any iterative searches since the solution for the above expression is in a closed-form [2], [62]. Indeed, biology does not seem to search in real time like a computer. The ML estimator of the vector vₜ from data cₜ₋₁ and the previous ML-estimate v*ₜ₋₁ means that the network DN-3 computes the best update as

v*ₜ←v*ₜ₋₁

that is most likely in probability for the observed event cₜ₋₁. In other words, each brain is the “best” for its environment. In this sense, “nice” or “evil” humans are due to “nice” or “evil” environments.

Therefore, a DN-3 learns any agent FA ML-optimally. Furthermore, a DN-3 learns any universal Turing machines ML-optimally. This means that a biological brain is modeled by DN-3 as an ML-optimal learner, under the Three Learning Conditions. A cognitively impaired (e.g., injured) biological brain is due to defects in the Four Learning Conditions, compared to those of normal brains. For example, if a young child is deprived of interactions with parents, his learning experience is defective.

There have been many biologically inspired neural networks that partially address some cognitive issues. However, they are not the biologically plausible emergent Turing machines here for a holistic brain that starts from a single cell. Some early network examples are in [86], [87]. Due to space limitation, we discuss only three well-known examples to illustrate some of the 20 million-dollar problems that any biological model for a brain must solve. Van Essen et al. [29], [55], [30] proposed a space shifter circuit for location invariance but did not specify how each neuron learns. “Deep machine learning” [59], [60], [79], [88], [18] addresses location invariance in space or time by biologically implausible convolution, thus, all the hidden features become unfortunately “concrete”—tied to a retina location or a particular time, not abstract or partially abstract. Tsotsos et al. [89] extended the Van Essen network to their two-way network, but (i) did not specify how each neuron learns and (ii) how each neuron finds its competitors. None of the three examples learn a finite Turing machine error-free on the fly like a DN that biology must do in one-shot learning.

Now, we are ready to present probably the most important mathematical formulation for the present model. As the above spatial networks are highly recurrently as the case with brains, any brain networks are extremely difficult for us to understand without the following formulation. Although derivatives can approximate small changes in nonlinear systems, we model a brain sampled in dense time to avoid approximations introduced by derivatives. Namely, our model does not have the errors introduced by derivatives. In particular, we do not require the response function of every neuron to be continuous and differentiable.

Sampled at discrete times, t=0, 1, 2, . . . , a DN learns any Turing machines by learning its transitions, but in a vector form, unfolding in time:

$$[ \begin{matrix}Z ( 0 ) \\ Y ( 0 ) \\ X ( 0 )\end{matrix} ] {\to }^{{f}_{0}} [ \begin{matrix}Z ( 1 ) \\ Y ( 1 ) \\ X ( 1 )\end{matrix} ] {\to }^{{f}_{1}} [ \begin{matrix}Z ( 2 ) \\ Y ( 2 ) \\ X ( 2 )\end{matrix} ] {\to }^{{f}_{2}} \qquad ( 3 )$$

where → means each neuron on the right adaptively links from some or all neurons on the left. Each area A(t) in {X(t), Y(t), Z(t)}, has a variable t since the dimension of A(t) changes with time t (e.g., cell splits and deaths). Such a link→ is established automatically as a multivariate mapping ƒₜ, t=0, 1, 2, . . . , and adapted according to the Lobe Component Analyses (LCA) [16] that models (unsupervised) Hebbian learning [73] conditioned on the firing of the post-synaptic neuron on the right.

The above vector-only expression unfolds time for the spatially highly recurrent brain. This time-unfolding technique is extremely important to understanding how a biological brain processes information in space and time, because the computations, after unfolding in time, is not recurrent-always from a time column to the next-time column on the right-hand side and no element in a column is allowed to take input from the same column. In other words, in biology, at any instant no neurons will wait (e.g., hold molecule flows) till other neurons complete their computations. All cells' computations are fully parallel. Although many agree with this parallel fashion, the brain networks have been often explained as spatial networks that are highly recurrent [90], but not time-unfolded, and therefore very difficult to understand and analyze.

Although Eq. (3) looks mathematically clean and simple, its miracle is the emergence of conscious actions in the motor Z area, when t is sufficiently large, and then the Z motor vectors are recursively used as the conscious state to facilitate further conscious learning (e.g., imitation, planning and discovery), as we will explain below.

We face two major issues: patterning and wiring the brain with a huge number of neurons and connections. Both issues must be solved automatically by individual neurons without a central government. While all individual neurons work according to its cell-centered rules of firing, adapting and synaptic maintenance, all to be discussed below, the entire brain formed by these neurons automatically improves the mapping (i.e., brain tissue patterning) from the left column at time t−1 to the right column at time t in a “coarse to fine” meaner. The entire set of earlier-spawn neurons approximates a score approximation of brain pattern for the context space observed then; the entire set of later-spawn neurons join the early-spawn neurons to incrementally refine the earlier and coarse brain pattern. Such a coarse-to-fine brain patterning is more biologically effective than requiring many neurons to globally approximate a fine brain pattern. Incremental refinements are local and therefore biologically plausible for many neurons to work in parallel (without a government) to reach a globally optimal brain pattern at each instant.

Inside the DN-3, each neuron automatically finds the zone of its competitors, also in such a coarse-to-fine way. Since each neuron has its own adaptive competition zone, the architecture of the brain is fully fluid, allowing any consciousness bounded by the computational resources (e.g., number of neurons). This is a major difference of DN-2 from DN-1 which has a fixed network of Brodmann areas where neurons in each Brodmann area share the same (mutual) competition zone.

How does each neuron determine what it does? Our model must avoid a static circuit that must be task-specific like a radio. It must not statically specify which neurons do what because otherwise the brain cannot develop any hierarchy that any consciousness needs (e.g., must not be the static one drawn as an example in FIG. 1). In biology, role determination is accomplished through competition, like in market economy. For competition, there are two types of value-free neural transmitters, excitatory (e.g., glutamate) and inhibitory (e.g., GABA) [6]. By value-free, we mean neither good nor bad, different from a reinforcer signals discussed below. Neurons that send excitatory transmitters are called positive neurons. Neurons that send inhibitory transmitters are called negative neurons, although there are no negative values in biology. For simplicity, we assume positive neurons and negative neurons form many one-to-one correspondence pairs. It is worth noting that they do not have to be pairs. A smooth representation implies that a certain density of both types is sufficient, like FIG. 17-11 in [6].

Statistically speaking, competitors of a positive neuron nᵢ mean those other positive neurons that do not fire when the neuron nᵢ fires. Mutually competing positive neurons detect different features from the same input field. To find competitors, biology uses negative neurons. The negative neuron also learns according to the Hebbian rule and synaptic maintenance discussed below, which then automatically finds its input neurons as the competitors of the corresponding positive neuron. A negative neuron fires if and only if its positive neuron does not fire.

As brain-scale competition rules, the connection rules below are improved from [91, Property 6.1]:

Proposition 1 (Brain connection rules): Given any two positive neurons nᵢ and nⱼ, i≠j, i≥1, j≥1, either within a brain area or between two brain areas, consider four neurons nᵢ, nⱼ and their negative neurons n₋ᵢ and n₋ⱼ, as two pairs (nᵢ, n₋ᵢ) and (nⱼ, n₋ⱼ). Among these four, there are only excitatory connections. Assume each positive neuron nᵢ is near to his inhibitory neuron n₋ᵢ [6]. They result in five connection possibilities:
1) nᵢ excites nⱼ (nᵢ connects to nⱼ): if nᵢ fires, nⱼ has a high probability to fire, P(nⱼ(t)|nᵢ (t−1))>T.
2) nᵢ inhibits nⱼ (nᵢ connects to n₋ⱼ): P(nⱼ(t)|n₋ᵢ(t−1))>T.
3) nⱼ excites nᵢ (nⱼ connects to nᵢ): P(nᵢ(t)|nⱼ (t−1))>T.
4) nⱼ inhibits nᵢ (nⱼ connects to n₋ᵢ): P(nᵢ(t)|n₋ⱼ (t−1))>T.
5) Otherwise (nᵢ, nⱼ, n₋ᵢ, n₋ⱼ are all disconnected): None of the above conditions are true.
   The value T>0.5 is a composite effect of the Hebbian learning and synaptic maintenance to be discussed below. In particular, receptor neurons in the primate retina do not inhibit one another (without negative neurons) because one does not predict another, Case 5) above.

Let us revisit Eq. (3). The motor area Z(t) is the vector space corresponding to the state space Q′={(q′, γ′, d)} at time t in a symbolic Turing machine. The sensory area X(t) is the vector space corresponding to the symbolic input space Γ={γ}. The hidden area Y(t), absent from all symbolic Turing machines, is the emergent (learned) representation of the skull-closed brain that conducts the search and the interpolations of the vector space mapping from time t−1 to time t. A symbolic Turing machine conducts search according to exact match of two symbols, absolutely yes or no. The hidden area conducts search in parallel, by all of its hidden neurons, while they also compete with one another. In other words, the numerical interpolation replaces the rigid look-up table in a traditional symbolic Turing machine.

For notation conciseness, define c=(x, y, z)∈X×Y×Z as a context. Thus, the three-area transitions in Eq. (3) corresponds to notation-concise context transitions:

$${c}_{0} {\to }^{{f}_{0}} {c}_{1} {\to }^{{f}_{1}} {c}_{2} {\to }^{{f}_{2}} \qquad ( 4 )$$

where cₜ∈X(t)×Y(t)×Z(t), t=0, 1, 2, . . . and ƒₜ=(ƒₓ, ƒ_{y}, ƒ_{z}) is the brain function that uses values at t. We use t as a subscript to indicate that the vector does not need to be stored across different times.

At each time t, the physical world provides the last “objective” sensory vector xₜ₋₁∈X(t−1); the brain provides the last “subjective” context (yₜ₋₁, zₜ₋₁)∈Y(t−1)×Z(t−1)). Its “brain” function ƒₜ₋₁ produces a current motor vector zₜ and a current internal response yₜ as the current “subjective” context (yₜ, zₜ) from ƒₜ₋₁ (xₜ₋₁, yₜ₋₁, zₜ₋₁). The motor vector z could be either taught by a teacher or, more relevant to a brain model, self-generated. To self-generate z, the new born recalls from a set of “innate” motor vectors learned by the inborn brain and body. Later, the more mature brain recalls from its more mature brain and body.

Unlike symbolic states in a Turing machine, a state as vector z E Z emerges autonomously without any humans in the loop defining and feeding symbols. This is the most fundamental reason for fully autonomous learning, so that the learner can become increasingly aware through its own interactions with the physical environment. Therefore, the motor area Z(t) takes input from Y(t−1)×Z(t−1) and becomes more and more sophisticated from its “living” experience. Z(t) may take input also from X(t−1) for very simple species.

### IV. DEVELOPMENTAL NETWORK 3

We are ready to present the DN-3 Time-Level Algorithm.

### A. Time-Level Algorithm

Input areas: X and Z. Hidden area (brain): Y. Output area: Z.
1) At time t=0, each of the X, Y and Z areas has a single neuron. The Y neuron is fully connected from X, Y and Z areas. The Z area is fully connected from the X, Y and Z areas. Components in three neurons x(0), y(0), and z(0) are initialized by small and random signals (called spontaneous activities). The ages of the three neurons are zero and connection weights of the three neurons are random. Then, do step 2) repeatedly till death.
2) Advance time t←t+1 and perform a), b) and c) below in parallel before doing d):
   a) All X neurons (receptors) may take inputs from the world (e.g., after the eyes open). Compute the X area's response vector x(t) and the adaptive part N (weights, ages, connections and more to be defined below) in parallel:

(x(t),N′ₓ)=ƒₓ(pₓ(t-1),Nₓ) (5)
where pₓ(t−1)=(x(t−1), y(t−1)), and ƒₓ is the X area function to be explained below. Split when the time is up.
b) All Z neurons (muscle or motor neurons) compute Z area's response vector z(t) and the adaptive part N′_{z} in parallel:

(z(t),N′_{z})=ƒ_{z}(p_{z}(t-1),N_{z}) (6)
where p_{z}(t−1)=(y(t−1), z(t−1)), and ƒ_{z} is the Z area function to be explained below. Split when the time is up.
c) All Y neurons compute the area's response vector y(t) and the adaptive part N′_{y} in parallel:

(y(t),N′_{y})=ƒ_{y}(p_{y}(t-1),N_{y}) (7)
where p_{y}(t−1)=(x(t−1), y(t−1), z(t−1)), and ƒ_{y} is the Y area function to be explained below. If active Y neurons' responses are less than a threshold (age-dependent nerve growth factor), these Y neurons split into a parent neuron and a new child neuron.
d) Update asynchronously: Nₓ←N′ₓ, N_{y}←N′_{y} and N_{z}←N′_{z}.

The area functions ƒₓ, ƒ_{y} and ƒ_{z} include 1) the computation of response vectors x(t), y(t) and z(t) and 2) the maintenance of adaptive parts N′ₓ, N′_{y} and N′_{z}, respectively.

Let us discuss details of the area function. The following update applies to any neuron in any area A∈{X, Y, Z} where ∈ denotes “in”.

### B. Pre-Response

At time t, each neuron nᵢ (except receptors in sensors) has an input vector pᵢ(t−1) from other neurons and a weight vector wᵢ(t−1). To normalize a noisy vector v=(v₁, v₂, . . . v_{d}), where v is either pᵢ (t−1) or wᵢ(t−1), the neuron incrementally computes the minimum normal lₘ and maximum norm l_{M} of the vector v from each norm l(t−1)=∥v(t−1)∥ which are initialized by a huge number and zero, respectively. (In 3D: ∥(v₁, v₂, v₃)|=\sqrt{v₁²+v₂²+v₃²}) Add an additional component so that when the norm is near the minimum, the normalized vector is nearly vₐ=(0, 0, . . . , 0, 1), d zeros followed by a single 1, thus the augmented vector vₐ does not boost small noise as many different patterns:

$${v}_{a} = ( \frac{l ( t - 1 ) - {l}_{m}}{{l}_{M} - {l}_{m}} v , \frac{{l}_{M} - l ( t - 1 )}{{l}_{M} - {l}_{m}} ) \qquad ( 8 )$$

Update the minimum norm lₘ and maximum norm l_{M} of the vector v:

lₘ←min{lₘ,l(t-1)};l_{M}←max{l_{M},l(t-1)}. (9)

Normalize vₐ that is never a zero vector in denominator because of the added (d+1)-th component in vₐ to represent a zero v:

$$\dot{v} = \frac{{v}_{a}}{‖ {v}_{a} ‖} . \qquad ( 10 )$$

The norm ∥vₐ∥ in the denominator normalizes the “contrast” of vector vₐ and \dot{v} denotes the normalized v. In the above way, compute the normalized pᵢ(t−1) as \dot{p} and the normalized wᵢ(t−1) as \dot{w}. Compute the pre-response of neuron nᵢ as the product of two unit vectors:

r′ᵢ(t)=\dot{w}·\dot{p}. (11)

### C. Competition

To simulate adaptive inhibitions, each positive neuron nᵢ has a unique negative neuron n₋ᵢ whose role is to record the competitors of its dedicated positive neuron. Namely, brain neurons are in pairs {(nᵢ, n₋ᵢ)|i=1, 2, . . . }. Because of the freedom of each nᵢ to work with n₋ᵢ to find its individual role, the hierarchy of the positive neurons can be of any complexity (e.g., topology and number of levels) and so is the consciousness.

Define the local inhibition zone for each n neuron to be those neurons that n₋ᵢ connects from and whose weight is larger than the current average weight of the negative neuron. Both nᵢ and n₋ᵢ are initialized at the same time (at the inception and every split) and both learn using the Hebbian learning step 3) and both conduct the synaptic maintenance discussed below. For each positive neuron nᵢ, if its pre-response value is within top-k (k is a small percentage among the competitors which changes from large to small through lifetime) of the pre-response values of its competitors, it fires and updates. Otherwise, its negative neuron n₋ᵢ fires and updates. The above rules simulate the complete mutual inhibitions between nᵢ and n₋ᵢ. See e.g., [6, FIG. 17-11].

### D. Learning

Learning is probably the most challenging issue in modeling a biological brain. This model has four categories of learning mechanisms all of which must be done fully automatically inside the skull: (1) Hebb's mechanism—Lobe Component Analysis (LCA) [16] that is dually optimal. (2) Synaptic maintenance that grows and cuts connections actively [92]. (3) Motivated learning using four categories of neural modulators [93], [93]—without using symbolic time-discount in Q-learning [75], and (4) Cause-to-fine refinements and recruitments—new here—from a single neuron for the neuronal placement and routing, also called brain patterning.

Because the skull is closed, we should not allow any human teachers to open the skull and dictate (or supervise) which hidden neurons to fire, unlike LSTM models [81] that use so called “gates”. Furthermore, because the motor end of a baby learner does not have an error signal, the error-backprop method [74] is biologically implausible. Worse, the error-backprop method requires all connected pre-synaptic neurons to help, recursively backwards through synaptic hops, and to reduce the error at each time the error arises. But reducing the error is not the duty of many connected pre-synaptic neurons! That is why the error-backprop method is bound to have many local minima and relies on an erroneous protocol called PSUTS (Post-Selection Using Test Set) [15], [26]. The same is true for Q-learning, since the current value is not the duty of many connected pre-synaptic neurons—the weakness of time-discount! One must work hard (short-term pains) to get a PhD (long-term gains or high-level consciousness).

1) Hebbian learning: Hebbian learning deals with the learning of existing synaptic weights. Donald Hebb 1949 [94] published what is later called Hebb's postulate [73]: “Let us assume that the persistence or repetition of a reverberatory activity (or ‘trace’) tends to induce lasting cellular changes that add to its stability . . . . When an axon of cell A is near enough to excite a cell B and repeatedly or persistently takes part in firing it, some growth process or metabolic change takes place in one or both cells such that A's efficiency, as one of the cells firing B, is increased.”

Unlike supervised learning and value-supervised reinforcement learning, the Hebb's postulate does not require direct supervision of firing. It states only that when neuron A excites neuron B, e.g., separated by a single time frame, the connection from A to B is strengthened. However, Hebb's postulate does not tell why A or B fires. In Sec. IV-C, B=nᵢ has competitors that its negative neuron n₋ⱼ helps to find.

Because we must model how neurons find their rules through competitions, we must not just consider A excites B, but also the competitors of B.

In neuron B=nᵢ's local competition zone Cᵢ: ρ(i)=rank max_{j∈C}_{ᵢ}(r′ⱼ), rank the top-(k+1) pre-responses of the competitors of B: r′_{1,i}≥r′_{2,i} . . . ≥r′_{k+1,i}.

If neuron nᵢ is among top-k winners, scale its response value rᵢ(t) in (0, 1]:

$${r}_{i} ( t ) = \frac{{r}_{ρ ( i ) , i}^{′} ( t ) - {r}_{k + 1 , i}^{′} ( t )}{{r}_{1 , i}^{′} ( t ) - {r}_{k + 1 , i}^{′} ( t )} . \qquad ( 12 )$$

If B is at the top, ρ(i)=1, rᵢ(t)=1. If ρ(i)=k+1, rᵢ(t)=0, not firing. If 1<ρ(i)<k+1, B fires at 0≤rᵢ(t)≤1. Otherwise, rᵢ(t)=0. If the positive neuron nᵢ does not fire, its negative neuron n₋ᵢ files.

When 1≤ρ(i)≤k, the neuron nᵢ fires, its firing age is incremented aᵢ←aᵢ+1 and each component wᵢⱼ of its weight vector wᵢ is updated as:

wᵢⱼ←β₁(aᵢ)wᵢⱼ+β₂(aᵢ)rᵢ(t)\dot{p}ᵢⱼ(t−1). (13)

where \dot{p}ᵢⱼ(t) is j-th component of input vector \dot{p}ᵢ(t), β₂(aᵢ) is the age-dependent amnesic learning rate depending on the firing age of this neuron and β₁(aᵢ) is the age-dependent amnesic retention rate, β₁(aᵢ)=1−β₂(aᵢ).

Let us take a simpler non-amnesic version β₂=1/k where k is the age aᵢ at firing time t=tₖ, k=1, 2, . . . , n. Eq. (13) is the recursive computation of the average of response-weighted input components up to time tₙ:

$${w}_{ij} = \frac{1}{n} {\sum }_{k = 1}^{n} {r}_{i} ( {t}_{k} ) {\dot{p}}_{ij} ( {t}_{k} - 1 ) . \qquad ( 14 )$$

Let us discuss how the Hebb's postulate is realized by this expression. The neuron A is nᵢ and the neuron B is nⱼ and wᵢⱼ is the weight of connection from A to B. Under the summation rᵢ (tₖ)\dot{p}ᵢⱼ (tₖ−1) is the product of two factors, \dot{p}ᵢⱼ(tₖ−1) being the pre-synaptic response of neuron A=nᵢ at time tₖ−1 and rᵢ(tₖ) being the post-synaptic response of neuron B=nⱼ at time tₖ. Both must fire and be high for the product to be high—what Hebb means by “excite”. The summation over only the times when both fire (product is none-zero) is what Hebb means by “repeatedly or persistently”.

The dually optimality of LCA means that the weight vector of B is incrementally computed first principal component vector (PCV) of the covariance of input vector of B, taking into account only when B fires. The dually optimality is twofold. The first optimality means that each estimate of the ˜ weight vector is the best representation so far for the principal component objective: The PCV vector is the among all possible vectors in the input space of B that has minimum representation error. In other words, the PCV weight vector of B is the best representation of B's input space through competition—like “market economy”. The second optimality means that the direction represented by rᵢ(tₖ)\dot{p}ᵢⱼ(tₖ−1) for all i, the step sizes β₂=1/k and the retention sizes β₁=1−1/k are all optimal toward the PCV.

Namely, LCA is the dually optimal version of the Hebb's postulate taking into account the competition zones (not in the Hebb's postulate) that are tuned by individual post-synaptic neurons. This per-neuron competition zone is critically important to avoid a static architecture (e.g., a network of a fixed number of Brodmann areas [55]) that would otherwise defeat the need of an arbitrarily complex architecture needed by consciousness.

The amnesic version of the learning rate β₂ is given in [16] so that an old neuron is still sufficiently plastic.

A negative neuron updates using the same rules as a positive neuron.

2) Motivation and reinforcement learning: Motivation and reinforcement learning deals with learning of low-level values of (biased) sensors, such as pain sensors and sweet sensors. Motivation in DN-3 is mediated by two classes of neuromodulators, 5-HT and DA, in addition to “value-free” neurotransmitters glutamate (excitatory) and GABA (inhibitory) used by positive neurons and negative neurons. Serotonin 5-HT represents “bad value” (like pain) and dopamine DA represents “good value” (like sweet). Pain sensors signal the ventral tegmental area (VTA) to synthesize 5-HT which is sent to the entire brain through diffusion (not via neuron-to-neuron firing). Sweet sensors signal the raphe nuclei to synthesize dopamine, which is sent to the entire brain also through diffusion. Both 5-HT and DA cause all firing Y neurons to learn faster by increasing their Hebbian learning rate. 5-HT and DA affect the firing Z neurons differently: Incrementally accumulated conductance of the 5-HT receptors of a Z neuron reduces its pre-response value so that it is harder to win and fire in the future. Incrementally accumulated conductance of the DA receptors of a Z neuron increase its pre-response value so that it is easier to win and fire in the future. In summary, both 5-HT and DA increase the learning rate of hidden neurons, but have opposite effects on motor neurons. Weng et al. [91], [62] provide mathematical expressions and simulations.

Based on the growth of language neurons in Z area, we have modeled how such low-level motivations, pain, sweet, are transferred to the highly motor concepts (levels 1 to 5) of consciousness, such as a sense of value and ethics.

The four classes of neuromodulators, 5-HT and DA in pleasure seeking and pain avoidance here, along with ACH and NE in the synaptic maintenance below, play neuromorphic roles of values.

3) Synaptic maintenance for learning connections: Synaptic maintenance deals with learning of role 1s by each neuron. We need to first discuss the 3D location of a neuron in the skull. The soma of each neuron has a 3D location inside the brain. To simulate such locations so that the brain model here can be used to study the map of a biological brain as well as to visualize the representations inside the skull, each neuron in the DN-2 has a 3D location. In DN-3, the first neuron is at the center of the brain's 3D skull. We model glial cells that distribute uniformly inside the 3D skull. These glial cells support the positions of neurons and update the positions by pulling nearby neurons in real time, to simulate morphogens released from glial cells in cortical patterning [44]. The force of pulling is proportional to the distance between a glial cell and a neuron [62]. As soon as such pulling forces from all glial cells are balanced, the neuron's location reaches a dynamic equilibrium. Otherwise, the neuron moves in the direction with more nearby glial cells.

Our model must have a constant complexity in the skull volume, because the number of molecules is constant in space. Pulling of b brain neurons from g glial cells requires an O(bg) complexity if a global search is performed for nearest k glia. If g≈b, this amounts to O(b²), a square complexity, not constant. But biology uses local morphogens, which does not do a global search. The present model avoids such a global search using imaginary glia that are spawn along a regular grid (simulating a certain density). For example, 1B=10⁹ glia in a cube are at all-integer coordinates (i, j, k) where i, j, k are integers, 1≤i, j, k≤1000. (A 3D skull mask marks all glia that are outside the skull.) For each neuron at real coordinates (h, w, d) inside the cube, the nearest glia is at ([h], [w], [d]) where [x] is the nearest integer of x, without a need for search. The same is true for expanding to top-k (k>1) nearest glia. Thus, the combined pulling force [62][Eq. (30)] from the top-k glia also does not do a global search. Thus, the computational complexity of placing neurons in 3D is proportional to the number of glial cells and the number of neurons, a constant in the skull volume.

Now, we are ready to address synaptic maintenance. Synaptic maintenance (for positive and negative neurons) is fundamental for a huge number of neurons in the brain to find where to connect from in a process of coarse-to-fine patterning based on prenatal and postnatal activities. It is carried out only when a neuron (positive or negative) fires. Hebbian learning in Eq. (13) assumes and tunes connection weights but does not find connections and rarely cut connections completely.

Yu & Dayan [95] proposed that expected uncertainty and unexpected novelty are computed and represented using Acetylcholine (ACH) and Norepinephrine (NE), respectively. In Weng et al. [91], [62] we modeled how ACH and NE are used by each neuron to cut connections that are beyond expected uncertainty and grow connections that are well within expected uncertainty. Each synapse incrementally computes the temporal deviation between the corresponding input neuron and the corresponding synaptic weight. The incrementally computed such deviation across all synapses of a neuron is represented by ACH as expected uncertainty of the neuron. The incrementally computed difference above the deviation at each synapse is represented by NE as novelty [95], [91] at each synapse. If the NE at a synapse is smaller then ¼ of ACH of the neuron, the neuron grows the dendrites around the input neuron to more nearby neurons. Otherwise, if the NE at a synapse is larger than ¾ of ACH of the neuron, the neuron cuts the synapse. See Weng et al. [91], [62] for mathematical expressions and [92], [33] for simulations.

In summary, each neuron tries to find a largest possible stable feature to detect. The synaptic maintenance not only cuts unstable synapses but also grows stable synapses. Thus, a smooth brain representation is important for the success of brain's government-free role finding. A smooth representation means nearby neurons in 3D represent similar features.

For example, the neighboring receptors (rods and cones) in the retina allow the synaptic maintenance to automatically wire from each non-uniform receptor to hidden neurons in the lateral geniculate nucleus (LGN), without requiring each hidden neuron to have a target “address” in the retina. The reduced resolution in the peripheral retina is important to contain the total number of hidden neurons in the LGN. Across the entire brain, the coarse-to-fine patterning model here makes this daunting task of auto-wiring 10⁵ to 10¹¹ neurons biologically plausible, free from a government.

The above four types neural modulators, 5-HT, DA, ACH and NE, act as four basic categories for many more finer classes of neuromodulators in higher animals.

4) Coarse-to-fine brain pattern learning: Coarse-to-fine brain patterning is the learning of brain's overall connections (brain Connectome). It is important for the brain to develop from a single cell, so that the approximation of brain patterning is approximated by each cell without a need for a central government.

Each area A has its own nerve growth factor, but the sensory X and motor Z areas grow toward a final number of neurons faster and earlier than the hidden Y area. When the nerve growth factor accumulates above an amount, neuronal splits take place, which consumes an amount of the nerve growth factor.

When a neuron in an area A in {X, Y, Z} splits, the child neuron takes all the parameters and connections (including receptive field and effective field) from the parent, but its age is zero. Thus, as X and Z grows with time, the sensory receptive field of a hidden neuron grows accordingly. If a neuron links from a parent, it links from its child too, so that the child is not isolated.

The hidden Y area grows adaptively on demand: If the pre-response of a firing (positive) neuron is lower than the almost perfect match m(t),

m(t)=α(t)(1−θ) (15)

where θ>0 is small, modeling neuronal noise level; α(t), 0<α(t)≤1, is the nerve growth factor that modulates the peed to split the positive neuron and its negative neuron. The smaller α(t), the faster the growth. A positive neuron fires if and only if its negative neuron does not fire (i.e., complete inhibition between the two). Weng et al. [62] provides mathematical details and simulations of splits and differentiations.

New for DN-3 here is a need for mitosis to spawn more neurons from neurons that often fire, so that busy-firing neurons generate more new neurons. The nerve growth factor α(t) is a function ƒ which depends on the lifetime t and an amnestic average of hourly firing rate r̅ₕ(t):

$$α ( t ) = f ( t , {\overline{r}}_{h} ( t ) ) = \frac{min \{ {β}_{0} {r}_{0} , {β}_{1} max \{ {\overline{r}}_{h} ( t ) - {r}_{0} , 0 \} \}}{{β}_{0} {r}_{0} + {β}_{1} max \{ {\overline{r}}_{h} ( t ) - {r}_{0} , 0 \}} {g}_{l} ( t ) \qquad ( 16 )$$

where r₀ is the expected base hourly firing rate of a neuron; max{r̅ₕ(t)−r₀, 0} is the firing bonus above expectation; β₀ and β₁, with β₀+β₁=1, weight jointly how much the base r₀ and the bonus max{r̅ₕ(t)−r₀, 0} shape α(t); and g(t), 0<gₗ(t)≤1, is a monotonely increasing function that gives growth scheduling over lifetime. If the bonus is zero, the first factor equals to 1 and α(t)=gₗ(t). If the bonus is larger than zero, the first factor is smaller than 1 and α(t)<gₗ(t).

When the number of hidden neurons fills the skull capacity, set α(t)=1, to stop growth.

Deaths occur for neurons whose decade-average r̅_{d}(t)≈0 to recycle dead neurons back into mitosis using Eq. (16). Thus, decade reviews are important for humans to keep old memory.

In summary, starting from a single cell in the brain, the computational intractable requirement for any-to-any neuronal connection in Proposition 1 becomes tractable, local, and constant O(nc) in a computational complexity for updating the entire network, where O(ƒ) indicates the upper bound of the growth rate ƒ, and n is the number of neurons in the adult brain (n≈10¹¹ for humans) and c is the average the number of connections per neuron (c t 10³ for humans). Thus, the computational complexity of DN-3 update is constant in the total number nc of connections.

Traditionally, in a design of computer chips, this process of placing and routing is done manually [96] or partially assisted by a machine learning procedure [97]. This DN-3 model seems to be the first model that does placing and routing fully automatically inside the skull across the entire life for general-purpose consciousness and intelligence. This fully automated placing and routing procedure takes advantage of the restrictions in the DN-3 model, not for any computer chips. Likewise, automatic placing and routing in an animal brain also takes advantages of the restrictions in the animal genome.

Up to this point, we have explained how a DN-3 runs. But we have not explained how the DN-3 works to generate consciousness and intelligence in a real physical world, which includes parents, teachers, and peers. This is the main subject of the following two sections.

### V. CONSCIOUS LEARNING VIA AUTONOMOUS IMITATION

We will explain that conscious learning is a process of imitation that is largely innate, autonomic and simple in early lifetime and increasingly learned, purposeful and complex in later lifetime.

Weng [70] established that using motor-imposed training, a DN ML-optimally learns any grounded Turing machine. If the Turing machine is universal, the DN conducts APFGP. The inventor argues that APFGP is a computational characterization of consciousness as defined in dictionaries. However, motor-imposed training seems to be temporally sparse in biological learning.

Interestingly, imitations are central to APFGP and consciousness. Let us formally define autonomous imitation.

Definition 3 (Autonomous imitation): A conscious learning agent conducts autonomous imitation of a sensed 3D event in its environment (that is occurring in the real world or being recalled from memory), if the learner's action sequence imitates the 3D event and a human expert judges that the action sequence indeed resembles the original 3D event to an acceptable degree. The imitation is autonomous if such an imitation is not a pre-given task in writing the learner's program and the leaner's effector is not motor-imposed by a teacher.

FIG. 4 shows an example of autonomous imitation of phone-call play. Specifically, the 3D event to learn is “a hand places a block on an ear”. The kid sees that 3D event played by a teacher and his action sequence caused “a hand places a block on an ear”.

Definition 3 does not specify how the 3D event is projected onto the agent's sensors. Neither does it specifies how the agent's effector sequence is judged to resemble the original 3D event. Such detail is filled according to the goal of teaching. Definition 3 does not forbid a use of biased sensors to motivate the learner. In animal training, use of reinforcers (e.g., food or touch) is typical.

If the imitation only involves external effectors, motor-imposed teaching is still possible.

However, if the imitation involves skull-internal behavior such as attention (e.g., attention to ear), motor-imposed training is not directly available. A human teacher may use body signs or verbal languages as part of 3D event to facilitate the emergence of imitative behaviors. For example, the teacher could say, “notice the ear” or simply “ear”.

For conscious learning, the 3D events displayed by a teacher or the physical could involve levels 1 to 5 of consciousness. The above Ukraine war example in Sec. I involves all levels 1 to 5 of consciousness in Putin's brain: (1) social cause (e.g., national security), (2) state of thought (e.g., the current state of security planning), (3) totality of conscious state of major players, Ukraine, Russia, the E.U., the U.S. and the NATO, (4) the state of self life as the Russia's president, and (5) the upper level of mental life: possible outcomes from a Ukraine war. During driving, handling the problem of a traffic jam or detour may also involve these 5 levels.

### VI. ANALYSIS OF CONSCIOUS LEARNING BY DN-3

It is interesting that the Conscious Learning Algorithm (DN-3) did not specify imitation as a pre-given task, or any concepts needed in a train of conscious thoughts! We must not specify because we do not know what species will use this DN-3 algorithm and what 3D event needs consciousness to assist its imitation.

A conventional AI method, widely practiced in computer vision and other AI areas, is to hand-label every concept required. For the “where” concept. the label would be a pair (r, c) for r-th row and c-th column in every image. For the “what” concept, the label would be a class label, such as “hand, block, ear, near”. These labels are imposed to the motor area of the learner. This type of training, called motor-imposed training with seb=010, is avoided by autonomous imitations.

One issue is that the amount of computational power (e.g., the number of neurons in the brain) is very large due to the real world complexity. For future real-world computer simulations of the present brain model, the availability of brain-size and real-time learning chips—brainoid chips—is indeed a current bottleneck in electronics engineering.

Proven mathematically, the predecessors DN-1 and DN-2 are optimal in the sense of maximum likelihood (ML) (see [2] for DN-1 and [62] for DN-2), under the Four Learning Conditions above. Namely, a DN-3 is ML-optimal further conditioned on its splitting speeds over lifetime from a single cell in each of the X, Y and Z areas. By ML, we mean that the DN-3 algorithm at t incrementally computes the closed-form solution to all the network parameters at time t from signals in sensory X, hidden Y and motor Z at time t−1, where the closed-form solution has the largest probability in a huge dimensional space. A DN-3 computes the ML-optimal emergent Turing machine, which is fully explainable. In other words, we only need to train one single network for each lifetime training experience without a need of Post-Selections [15].

The root reason for the DN-3 capability of emergence of consciousness is that the levels 1 to 5 in the definition of consciousness are all task nonspecific. The power of conscious learning is rooted in the methodology to set the learner free and empowering brain representations to use statistics like that in Proposition 1. For example, during early infancy, the motor area of the life is driven by a set of innate behaviors.

Some researchers improperly model a brain by handcrafting a flow diagram of blocks each of which is hand-assigned with a particular mental function (see, e.g., [98], [99]). This practice of course defeats our purpose to model emergence of any consciousness because different consciousness needs a different flow diagram.

Between an early imitation and an later imitation, no abrupt architecture changes should take place. This is because the mother is not allowed to open the skull to change the internal connections inside the brain. The main changes are signals and the resulting brain representations. Then, how can we explain that the same DN-3 algorithm enables the emergence of both the early imitation and the later imitation with an increased complexity in consciousness (or intelligence) for the later imitation? This is indeed a great challenge. Without improperly using an architecture change to explain the early imitation and the later imitation, as we will see below, we must use the same mapping mechanisms. Then, the major difference is the meanings of the involved signals.

Below, we analyze a) how innate behavior enables simple-motor imitations and b) how more ex-periences enable complex-motor imitations. The difference between an early emergence and a later emergence is not the letters like X, Y, Z that are central for our architecture in Eq. (3), but instead their subscripts that indicate the associated meanings.

### A. Simple-Motor Imitations

A single motor involves a single segment of the body, such as a vocal tract, a hand, an upper arm, etc. For driverless cars, single segments correspond to individual motors like steering, acceleration, braking.

Consider a simple imitation by babies-after hearing another baby B crying, infant A also cries. What happens in the brain?

When an infant A innately cries right after birth, the firing motor neuron zᵢₙₙₐₜₑ=z_{Acry} is the motor of crying that generates sounds x_{Acry} of A. Namely, sensory x_{Acry} is linked to motor z_{Acry}. When another infant B cries, the similar crying sounds of B, with x_{Acry}≈x_{Bcry}, are sensed by A that causes A to also cry.

This example can be generalized. When each Z vector zᵢₙₙₐₜₑ is innately firing in the motor, the corresponding physical effector as the corresponding 3D event is simultaneously sensed by the learner's sensors as a sensory event xₛᵢₘₚₗₑ. Both xₛᵢₘₚₗₑ and zᵢₙₙₐₜₑ take place concurrently, meaning DN learns association xₛᵢₘₚₗₑ→zᵢₙₙₐₜₑ. Then later zᵢₙₙₐₜₑ is invoked from a similar sensory event xₛᵢₘₚₗₑ like self-generated zᵢₙₙₐₜₑ from xₛᵢₘₚₗₑ. Namely, zᵢₙₙₐₜₑ becomes the “mirror neurons” [100] of xₛᵢₘₚₗₑ.

Theorem 1 (Early imitation): Early practiced action zᵢₙₙₐₜₑ is automatically invoked later from an associated sensory event xₛᵢₘₚₗₑ:

$${z}_{i n n a t e} {\to }^{phy} {x}_{simple} {\to }^{y} {z}_{i n n a t e} ⇒ {x}_{simple} {\to }^{y} {z}_{i n n a t e} \qquad ( 17 )$$

Proof: The proof follows from the above reasoning. In the above expression, “phy” stands for physics; y means internal hidden neurons in Y; the sign⇒means the left side practice during early life causes later autonomous imitation on the right side during later life. ▪

The A's crying is not necessarily exactly the same as B. Through later experience of many imitations, refined generalizations in the brain take place as context transitions based on learned emergent Turing machine. These generalizations are increasingly invoked by attended sensory features and motor concepts and become more sophisticated to enable imitations to involve complex 3D objects and complex body parts/concepts.

### B. Complex-Motor Imitations

A complex-motor event involves more than a single segment of the body, such as dancing by a horse and braking while making a turn by a human driver.

A human teacher demonstrates a complex-motor event, such as dancing. Each body component of the teacher has individual mirror neurons established above. The sensory samples of every body component are sensed by the neural network to excite the corresponding mirror neurons. Thus, attention to complex sensory components takes place by the firing multiple motor neurons, either through sequential attention or concurrent joint attention. Complex-motor imitations emerge automatically.

Theorem 2 (Complex-motor imitation): A complex-motor imitation capability is a later-time extension from the early imitation theorem, by extending the zᵢₙₙₐₜₑ to a later practiced complex-motor action z_{complex}. This extension requires more fine-tuned neurons yₘ in the neural network that tune their receptive fields to more relevant sensory objects x_{complex} that are sensed from complex-motor of the event.

$${z}_{c o m p l e x} {\to }^{phy} {x}_{complex} {\to }^{{y}_{m}} {z}_{complex} ⇒ {x}_{complex} {\to }^{{y}_{m}} {z}_{c omplex} \qquad ( 18 )$$

If the autonomous imitation is for a long sequence of event, the above arrows indicate triggering the starting context of the corresponding emergent Turing machine that drives a long sequence of events.

Proof: It is important that the above two expressions use the same x, y, z of the DN so that the same DN architecture will realize both expressions through more practice. However, zᵢₙₙₐₜₑ is replaced by z_{complex} that is learned through trial and error, and xₛᵢₘₚₗₑ is replaced by x_{complex} that is sensed also during trial and error. From Eq. (17), let zᵢₙₙₐₜₑ be replaced by z_{complex} and xₛᵢₘₚₗₑ by x_{complex}, both due to the expanded and improved attention. These expansion and improvement assume that early experience has enabled the neural network to fine tune its hidden feature neurons using Hebbian learning based LCA plus synaptic maintenance. Thus, replacing the symbol y in Eq. (17) by yₘ, we have the above expression. Note: the life continuously runs the same DN without any mode changes. ▪

Theorem 2 can be verbally summarized as “practice makes perfect”. For example, to learn how to drive cars one must try driving. This process also includes higher activities like book reading and scientific research.

It also helps to go back to Theorem 1 to see how a simple motor imitation is also a special case of a complex-motor imitation because a simple motor imitation and a complex motor imitation has the same form in terms of sensory vector x, motor vector z and hidden vector y.

Scaffolding in psychology [101] explains how a simple motor imitation can be used to acquire skills needed for generating increasingly complex motor action z_{complex} while the life goes on and on and the brain gets increasingly rich and complex. Namely, both Eq. (17) and Eq. (18) are automatically used multiple times and chained multiple times in a life while the life looks increasingly conscious as the time goes by.

### C. Time and Motion

The condition in our above discussion is sensory vector x_{complex}, which can also represent time. Time is a concept that the learner can learn through imitation and counting. E.g., counting fingers, 1, 2, . . . , 10 is a sequence of spatial events but also a time progression. Inside the DN, from the last context cₜ₋₁, the speed of context change of “where-and-what” of each 3D object affects the next context cₜ. Thus, the speed is registered in the sensory image xₜ and motor zₜ of the attended 3D object. Thus, the formulation of context transitions in Eq. (3) is not just about spatial patterns but also temporal patterns.

Thus, the concept of motion or time emerges as the condition to start an imitation. The starting time of imitation could be triggered by an environmental cue, e.g., teacher's nod during a class or the clock time to start doing homework.

### D. Imitation of Internal Attention

Imitation for internal attention is not motor-imposable, since there is no overt motor that corresponds to the attention. Suppose the teacher demonstrates “notice pedestrians”. It is impractical for the teacher to motor-impose “pedestrian” since vocal tract is inside the body—vocal tract—not imposable. However, if the learner has spoken “pedestrian” while its attention is on pedestrian, teacher's demonstration “pedestrian” (e.g., speak) causes “pedestrian” motor in the learner to fire. The firing boosts internal Y neurons through top-down connections so that the learner attends to pedestrians. Let us call this type of internal imitation language-directed imitation of internal attention.

### E. Generality and Creativity of Imitation

An imitation of 3D events involves attending to a few concepts and their relationships but exchanging some associated concepts, all of which have been learned by the conscious learner represented in its motor area.

In FIG. 4, three concepts are attended to: hand, block, and ear, and two concept-relationships are attended to, block-in-hand and block-near-ear. Two concepts are associated as human type but substituted, “I” substitutes “teacher’; two other concepts are associated as block type but substituted, “red” substitutes “green”; and two more concepts are associated as hand type but substituted, “left” substitutes “right”.

Using the generalization reasoning above, we can see that imitations are generally applicable to any observed events.

Theorem 3 (Generality and creativity of imitation): Thoughts by a natural or artificial learner via autonomous imitations of 3D real-world events are of general purposes per universal Turing machines. If the imitation result is judged considerably different but creative, such autonomous imitations correspond to creativity or discovery of the learner in the judge's eyes.

Proof: Conscious learning conditions in Definition 1 involve learning a universal Turing machine modeled as context transitions in Eq. (4). According to Theorem 2, an imitation composes a program as context transitions, regardless of a computer program or a task plan. The imitation involves attending to some components in contexts, but substituting some associated concepts. According to Eq. (18), this process includes learning to convert a 3D event (e.g., what is taught in a college class) sensed as a sequence of 2D sensory images in the form of x_{complex} and then to create a program as a sequence of motor signals in the form of z_{complex}, and finally to carry out the program back to the real world. Such compositions of programs correspond to general-purpose human thoughts as discussed in [28]. Therefore, the context transitions in Theorem 2 are of general purposes per universal Turing machines. The real-world result of the imitated program might not be a 100% duplication of the original 3D event and may be considerably different due to a variety of limitations in the real-world environment and the learner. If the difference is judged by a human expert as creative, the agent is creative in his eyes. The creativity is a discovery if the value of creativity is scientifically high. ▪

Whether an imitation is a children's play or a hypothesis of a scientific principle depends on how experienced the imitator is. The more experienced the imitator is, typically the more valuable the imitation is. The theory of creativity is for any subject matters.

Albert Einstein's work on general relativity could be considered a result of autonomous imitations through trial and error. Similarly, all physical experiments that verified the relativity theory are also autonomous imitations. However, the former is harder because the gap from the 3D events (published physics experiments that Albert Einstein had learned then) to the created program (the relativity theory paper) is significantly wider than the latter (from the published relativity paper to a plan to verify the correctness). Therefore, research awards should not be based on primarily how complete an experiment is, but on also how large the gap is between prior arts and a novel result as well as its impact.

F. Freedom from Post-Selections

Each biological life must develop normally. A model of biology is invalid if it demands Post-Selections of the luckiest one from many trained networks as criticized by Weng [15].

The hidden area Y(t) corresponds to the “brain” at time t. It consists of a large number of neurons whose response yₜ∈Y(t) is computed from each neuron's receptive fields in X(t−1)×Y(t−1)×Z(t−1).

Learning in Y and Z takes place incrementally in real time. The adaptive part (N′ₓ, N′_{y}, N′_{z}) also changes at each time t. Thus, ƒₜ=(ƒₓ, ƒ_{y}, ƒ_{z}) is different for each t.

In general, the Z area has a number of subareas, each of which may correspond to a limb or a concept (e.g., joint angles) which has a number of possible concept values but each time has only 1 concept value (e.g., a particular joint angle). Also, in general, each neuron in Y dynamically learns its competition zone in the context space. Furthermore, the X space is not shift-invariant either, but z∈Z learns invariant concepts.

As explained above, the present model does not use convolutions because the technique cannot abstract. Convolutions only computationally simulate the invariance of a single concept (e.g., locations), but not other concepts like types, orientations, and scales.

Without loss of generality, we consider below that each of the Y and Z areas uses only a global top-k (k=1) mechanism which self-picks the winner for the entire area.

At time t=0, the life inception takes place. z₀ is supervised at the initial state (e.g., representing initial state “none”). x₀ takes the sensory image at t=0. y₀ is a random vector. Each neuron nᵢ in Y and Z starts with random weights and firing age aᵢ=0.

From t=1, the network starts to update forever. Every neuron nᵢ in Y and Z computes their match between its weight wᵢ and the attended part pᵢ in input cᵢ as a inner product of two normalized vector \dot{w}ᵢ and \dot{p}ᵢ:

r′ᵢ=\dot{w}ᵢ·\dot{p}ᵢ.

A perfect match gives r′₁=1. Each area competes by finding the best matching neuron nⱼ.

$$j = {arg max}_{i} \{ {r}_{i}^{′} \} .$$

The winner nⱼ fires at rⱼ=1 and increments its firing age; all other losers i≠j do not fire and do not increment their firing ages. The winner neuron updates its weight vector using the ML-optimal Hebbian rule:

$${w}_{j} ← \frac{{a}_{j} - 1}{{a}_{j}} {\dot{w}}_{j} + \frac{1}{{a}_{j}} {r}_{j} {\dot{p}}_{j} .$$

The above incrementally computes the average of all response-weighted inputs for all times at which nⱼ has fired [16].

Why do random weights result in the same network? When the neuron nⱼ fires for the first time its age aⱼ=1, its retention rate

$$\frac{{a}_{j} - 1}{{a}_{j}} = 0$$

and its learning rate

$$\frac{1}{{a}_{j}} = 1 .$$

The initial random weight vector a only effects whether it is the winner but does not affect the updated weight, which must be exactly the response-weight normalized input rⱼ\dot{p}ⱼ. Yes, the ML-optimal estimate from the first sample is indeed the input sample! The above expression for the winner leads to the average in Eq. (14) of response-weighted inputs conditioned on the firing of neuron nⱼ which corresponds to the minimum-variance estimate of response-weighted inputs.

Because early age experience is not as important as the latest experience, an amnesic average increases learning rate

$$\frac{1}{{a}_{j}}$$

and accordingly reduces the retention rate so that the sum of them is still 1 [16].

In general, k>1 for top-k competition so that a small percentage of neurons fire each time, to result in smoother representational adaptations.

G. Freedom from “Big Data”

A human senses the 3D world using its sensors whose receptors lie in a thin sheet (retina, cochlea, skin) simulated as a 2D image. For general applicability of our method, we do not need to model the physical transformation from the 3D world to a 2D sensor since our baby brains must “calibrate” their sensors autonomously. Later, they have a chance in later life to learn physical laws that govern the mapping from the 3D world to the 2D receptor array. Sometimes, this mapping can be slightly changed, such as wearing a new pair of glasses. But a human brain can learn quickly and get used to the change. In summary, the present model enables each life to automatically calibrate the transformation from the 3D to the 2D.

There are three major reasons to model development of brains in terms of autonomous imitation.

First, imitations are 3D-to-2D-to-3D. A 3D-world event can be a temporal 3D event (e.g., finding how a tracked car turns), or a combination of space and time (e.g., how two moving cars collided). The sensory input to a learner is basically 2D. Autonomous imitations enable a learner to sense a 3D event using its 2D sensors and convert the 2D sensory information into its effectors that generate another but similar 3D event.

Second, autonomous imitations show whether the learner understands the demonstration of a 3D event.

Third, autonomous imitations reduce teaching complexity compared to motor-imposed training as we analyze below.

### H. Imitation Complexity

Let us analyze the imitation complexity and the saving enabled by imitation. Let a 3D event have n stages, as shown in FIG. 6 which is an abstraction in autonomous imitations of 1 demonstration (solid curves) and m−1 autonomous practices (dashed curves). In sensorimotor training the teacher chooses m but in autonomous imitation the learner chooses m autonomously. Within each stage, the learner must deal with m variations of stage-to-stage transitions (e.g., due to sensory variations).

Let n=10 and m=10. If we use a brute-force data-fitting network, the learning task requires mⁿ=10¹⁰=10 billion of event samples! Alternatively, if we use motor-imposed training for each stage using human imposed-motor, the same task requires mn=10×10=100 teaching examples, 10 teachings for each of the 10 stages. Finally, suppose that the machine is able to autonomously imitate using correct states in contexts, the teacher only needs to demonstrate n stages, one example for each stage. Then, during a later homework session, the learner is able to autonomously imitate for each of the remaining m−1=9 variations without a need for the teacher to demonstrate more. Thus, it autonomously generalizes to real-life experience of potentially mⁿ=10¹⁰=1 billion cases!

Theorem 4 (Imitations reduce teaching complexity): Suppose a task consists of n stages, where each stage consists of dealing with m variations. A brute force data fitting requires an exponential number O(mⁿ) training samples and O(mⁿsb) computations during training where s is the average receptive field size of neurons and b the number of neurons in the “brain” network. Motor-imposed teaching for an emergent Turing machine in DN requires O(mn) motor-supervision and O(mnsb) computations during training. Autonomous imitation by conscious learning requires O(n) demonstrations and O(mn) autonomous practices as well as O(mnsb) computations during demonstrations and autonomous practices.

Proof: We have already proven above for the training complexity. Let us deal with the number of network weights. Each network update requires O(sb) computations. The number of computations during learning is the number of samples times the number of computations in the network. Thus, we have O(mⁿsb) for brute-force data fitting, O(mnsb) for motor-imposed training with abstraction, and O(nsb) for n demonstrations, plus mnsb−nsb=O(mnsb) practices through autonomous imitations during homework. ▪

The most important concept in the above theorem is the reduction of teaching complexity, or equiv-alently, discovery from a single 3D event. Because autonomous imitations directly interact with the real world, they do not need a human teacher to collect a static and large data set and then hand-annotate this data set. Psychologists are amazed by how fast a child learns new sentences without much teaching [102], [103], [104], i.e., the undersample problem above. Theorem 4 is a computational account, alternative to the “language instinct” [103].

### VII. CONCLUSIONS AND DISCUSSIONS

The present model has established an algorithmic theory for brain consciousness and brain intelligence as (1) recursively learning 3D events in space and time, (2) recursively and creatively generating a program in 2D motor, and (3) recursively carrying out the program to 3D. Such a holistic brain model at a detailed computational level does not seem to exist in the existing literature. The theory that animal's recursively learned knowledge requires consciousness is also fundamentally new. The major advance from [70] is that the learner observes teacher's demonstrations using its sensors without motor-imposed training by a teacher and the advance from AI models in [34], [35] is that this work is for biology. As an approximation, this model is informed by biology, neuroscience and cognitive science.

However, fully holistic verifications of the present DN-3 model are still missing. These verifications can be conducted in two kinds of lives, natural and artificial. In biology, such a model hopefully could guide the designs of future studies and then would be subject to verifications, corrections, modifications and refinements. Drosophila [5], [37] is a good species to start tests on, thanks to its short life, low cost, and wide accessibility. In artificial intelligence, holistic simulations on lifelong robots requires the availability of brainoid chips. Such chips need to satisfy two kinds of requirements. The first kind is the computational power. The number of neurons, the number of connections, and the network refreshing rates are similar to those of an animal brain. The second kind is the dynamics of connections. They must be suited for the DN-3 mechanisms, especially coarse-to-fine patterning. If successful, robots would be able to automatically acquire human-like consciousness and human-like knowledge, from machine infancy to machine adulthood, with helps from human teacher demonstrations or without, since a real world also demonstrates its facts. However, although [2], [91] proved that a DN is optimal in the sense of maximum likelihood, rediscovery of human knowledge, such as Newtonian physics and Einstein's general relativity by robots, requires a very long time and much resources, although it is now possible with the new theory. Therefore, it seems important for biology to conduct experiments to verify this brain model and for engineers to teach conscious learning robots to read human-written books and attend human lectures.

### REFERENCES

[1] Inc. Merriam-Webster, editor. Merriam-Webseter's Online Dictionary. Merriam-Webster, Springfield, Massachusetts, 2022.
[2] J. Weng. Brain as an emergent finite automaton: A theory and three theorems. International Journal of Intelligence Science, 5(2):112-131, 2015.
[3] R. Dukas. Male fruit flies learn to avoid interspecific courtship. Behavioral Ecology, 15(4):695-698, July 2004.
[4] A. G. Dagaeff. Drosophila mate copying correlates with atmospheric pressure in a speed learning situation. Animal Behaviour, 121:163-174, November 2016.
[5] C. Lyu, L. F. Abbott, and G. Maimon. Building an allocentric travelling direction signal via vector computation. Nature, 601(7891):92-97, 2022.
[6] E. R. Kandel, J. H. Schwartz, and T. M. Jessell, editors. Principles of Neural Science. McGraw-Hill, New York, 4th edition, 2000.
[7] WSTDF. Closing ceremony. In Proc. the 3rd World Science and Technology Development Forum. WSTDF, Beijing China, Nov. 7, 14:00-16:40 2021.
[8] L. Hilderbrand, T. Posid, C. Moss-Racusin, L. Hymes, and S. Cordes. Does my daughter like math? relations between parent and child math attitudes and beliefs. Developmental Science, accepted:e13241, 2022. https://doi.org/10.1111/desc.13241.
[9] O. Mascaro and A. M. Kovacs. The origins of trust: Humans' reliance on communicative cues supersedes firsthand experience during the second year of life. Developmental Science, accepted:e13223, 2022. https://doi.org/10.1111/desc.13223.
[10] L. Q. Xiao, J. Y. Zhang, R. Wang, S. A. Klein, D. M. Levi, and C. Yu. Complete transfer of perceptual learning across retinal locations enabled by double training. Current Biology, 18:1922-1926, 2008.
[11] R. J. P. Simmons. Unconscious and conscious learning. In N. M. Seel, editor, Encyclopedia of the Sciences of Learning, Springer, New Boston, 2012. https://doi.org/10.1007/978-1-4419-1428-6_1077.
[12] M. Minsky. Logical versus analogical or symbolic versus connectionist or neat versus scruffy. AI Magazine, 12(2):34-51, 1991.
[13] L. Gomes. Machine-learning maestro Michael Jordan on the delusions of big data and other huge engineering efforts. IEEE Spectrum, Online article posted Oct. 20, 2014.
[14] O. Russakovsky, J. Deng, H. Su, J. Krause, S. Satheesh, S. Ma, Z. Huang, A. Karpathy, A. Khosla, M. Bernstein, A. C. Berg, and L. Fei-Fei. ImageNet large scale visual recognition challenge. International Journal of Computer Vision, 115:211-252, 2015.
[15] J. Weng. On post selections using test sets (PSUTS) in AI. In Proc. International Joint Conference on Neural Networks, pages 1-8, Shengzhen, China, Jul. 18-22 2021.
[16] J. Weng and M. Luciw. Dually optimal neuronal layers: Lobe component analysis. IEEE Trans. Autonomous Mental Development, 1(1):68-85, 2009.
[17] Y. LeCun, L. Bengio, and G. Hinton. Deep learning. Nature, 521:436-444, 2015.
[18] A. Krizhevsky, I. Sutskever, and G. E. Hinton. Imagenet classification with deep convolutional neural networks. Communications of the ACM, 60(6):84-90, 2017.
[19] J. Weng and M. D. Luciw. Brain-inspired concept networks: Learning concepts from cluttered scenes. IEEE Intelligent Systems Magazine, 29(6):14-22, 2014.
[20] Z. G. Szabo. Problems of Compositionality. Routledge, New York, 2000.
[21] J. Weng. Autonomous programming for general purposes: Theory. International Journal of Huamnoid Robotics, 17(4):1-36, August 2020.
[22] J. L. Elman, E. A. Bates, M. H. Johnson, A. Karmiloff-Smith, D. Parisi, and K. Plunkett. Rethinking Innateness: A connectionist perspective on development. MIT Press, Cambridge, Massachusetts, 1997.
[23] X. Wu and J. Weng. Neuron-wise inhibition zones and auditory experiments. IEEE Transactions on Industrial Electronics, 66(12):9581-9590, 2019.
[24] H. L. Dreyfus. What Computers Still Can't Do. MIT Press, Cambridge, Massachusetts, 1992.
[25] J. Weng. Natural and Artificial Intelligence: Introduction to Computational Brain-Mind. BMI Press, Okemos, Michigan, 2nd edition, 2019.
[26] J. Weng. A developmental method that computes optimal networks without post-selections. In Proc. IEEE International Conference on Development and Learning, pages 1-6, Beijing, China, Aug. 23-26 2021.
[27] A. M. Turing. Computing machinery and intelligence. Mind, 59:433-460, October 1950.
[28] X. Wu and J. Weng. On machine thinking. In Proc. International Joint Conf Neural Networks, pages 1-8, Shenzhen, China, Jul. 18-22 2021. IEEE Press.
[29] C. H. Anderson and D. C. Van Essen. Shifter circuits: A computational strategy for dynamic aspects of visual processing. Proc. Natl. Acad. Sci. USA, 84:6297-6301, September 1987.
[30] B. A. Olshausen, C. H. Anderson, and D. C. Van Essen. A neurobiological model of visual attention and invariant pattern recognition based on dynamic routing of information. Journal of Neuroscience, 13(11):4700-4719, 1993.
[31] M. Solgi, T. Liu, and J. Weng. A computational developmental model for specificity and transfer in perceptual learning. Journal of Vision, 13(1):ar. 7, 1-23, 2013.
[32] Z. Ji, J. Weng, and D. Prokhorov. Where-what network 1: “Where” and “What” assist each other through top-down connections. In Proc. IEEE Int'l Conference on Development and Learning, pages 61-66, Monterey, CA, Aug. 9-12, 2008.
[33] Q. Guo, X. Wu, and J. Weng. WWN-9: Cross-domain synaptic maintenance and its application to object groups recognition. In Proc. Int'l Joint Conference on Neural Networks, pages 1-8, Beijing, China, Jul. 6-11 2014.
[34] J. Weng. 3D-to-2D-to-3D conscious learning. In Proc. IEEE 40th International Conference on Consumer Electronics, pages 1-6, Las Vegas, NV, USA, Jan. 7-9 2022. http://www.cse.msu.edu/˜weng/research/ConsciousLearning-ICCE-2022-rvsd-cite.pdf.
[35] J. Weng. An algorithmic theory of conscious learning. In 2022 3rd International Conf on Artificial Intelligence in Electronics Engineering, pages 1-10, Bangkok, Thailand, Jan. 11-13 2022. http://www.cse.msu.edu/˜weng/research/ConsciousLearning-AIEE22rvsd-cite.pdf.
[36] J. Weng, J. McClelland, A. Pentland, O. Sporns, I. Stockman, M. Sur, and E. Thelen. Autonomous mental development by robots and animals. Science, 291(5504):599-600, 2001.
[37] J. Lu, A. H. Behbahani, L. Hamburg, E. A. Westeinde, P. M. Dawson, C. Lyu, G. Maimon, M. H. Dickinson, S. Druckmann, and R. I. Wilson. Transforming representations of movement from body- to world-centric space. Nature, 601(7891):98-104, 2022.
[38] M. Cole and S. R. Cole. The Development of Children. Freeman, New York, 3rd edition, 1996.
[39] B. Baars. Global workspace theory of consciousness: toward a cognitive neuroscience of human experience, chapter 4. Elsevier, New York, NY, 2005. Vol. 150.
[40] S. Dehaene, editor. Consciousness and the Brain. Viking, New York, NY, 2015.
[41] C. Koch, M. Massimini, M. Boly, and G. Tononi. Neural correlates of consciousness: progress and problems. Nature Reviews Neuroscience, 17(5):307-321, 2016.
[42] J. K. O'Regan, R. A. Rensink, and J. J. Clark. Change-blindness as a result of ‘mudsplashes’. Nature, 398:34, 1999.
[43] G. Munevar. A cellular and attentional network explanation of consciousness. Consciousness and Cognition, 83(4):102982, 2020. https://doi.org/10.1016/j.concog.2020.102982.
[44] M. Sur and J. L. R. Rubenstein. Patterning and plasticity of the cerebral cortex. Science, 310:805-810, 2005.
[45] Z. Zheng, X. Wu, and J. Weng. Emergent neural Turing machine and its visual navigation. Neural Networks, 110:116-130, February 2019.
[46] X. Wu and J. Weng. The emergent-context emergent-input framework for temporal processing. In Proc. International Joint Conf Neural Networks, pages 1-8, Budapest, Hungary, Jul. 14-19 2019. IEEE Press.
[47] J. Castro-Garcia and J. Weng. Emergent multilingual language acquisition using developmental networks. In Proc. International Joint Conf Neural Networks, pages 1-8, Budapest, Hungary, Jul. 14-19 2019. IEEE Press.
[48] D. H. Hubel and T. N. Wiesel. Receptive fields, binocular interaction and functional architecture in the cat's visual cortex. Journal of Physiology, 160(1):107-155, 1962.
[49] H. T. Ito, S. J. Zhang, M. P. Witter, E. I. Moser, and M. B. Moser. A prefrontal thalamo hippocampal circuit for goal-directed spatial navigation. Nature, 522:50-55, 2015.
[50] D. Silver, A. Huang, C. J. Maddison, A. Guez, L. Sifre, G. van den Driessche, J. Schrittwieser, I. Antonoglou, V. Panneershelvam, M. Lanctot, S. Dieleman, D. Grewe, J. Nham, N. Kalchbrenner, I. Sutskever, T. Lillicrap, M. Leach, K. Kavukcuoglu, T. Graepel, and D. Hassabis. Mastering the game of go with deep neural networks and tree search. Nature, 529:484-489, Jan. 27 2016.
[51] J. Schrittwieser, I. Antonoglou, T. Hubert, K. Simonyan, L. Sifre, S. Schmitt, A. Guez, E. Lockhart, D. Hassabis, T. Graepel, T. Lillicrap, and D. Silver. Mastering Atari, Go, chess and shogi by planning with a learned model. Science, 588(7839):604-609, 2020.
[52] A. W. Senior, R. Evans, J. Jumper, J. Kirkpatrick, L. Sifre, T. Green, C. Qin, A. Zidek, A. W. R. Nelson, A. Bridgland, H. Penedones, S. Petersen, K. Simonyan, S. Crossan, P. Kohli, D. T. Jones, D. Silver, K. Kavukcuoglu, and D. Hassabis. Improved protein structure prediction using potentials from deep learning. Nature, 577:706-710, 2020.
[53] N. Slonim, Y. Bilu, C. Alzate, R. Bar-Haim, B. Bogin, F. Bonin, L. Choshen, E. Cohen-Karlik, L. Dankin, L. Edelstein, L. Ein-Dor, R. Friedman-Melamed, A. Gavron, A. Gera, M. Gleize, S. Gretz, D. Gutfreund, A. Halfon, D. Hershcovich, R. Hoory, Y. Hou, S. Hummel, M. Jacovi, C. Jochim, Y. Kantor, Y. Katz, D. Konopnicki, Z. Kons, L. Kotlerman, D. Krieger, D. Lahav, T. Lavee, R. Levy, N. Liberman, Y. Mass, A. Menczel, S. Mirkin, G. Moshkowich, S. Ofek-Koifman, M. Orbach, E. Rabinovich, R. Rinott, S. Shechtman, D. Sheinwald, E. Shnarch, I. Shnayderman, A. Soffer, A. Spector, B. Sznajder, A. Toledo, O. Toledo-Ronen, E. Venezian1, and R. Aharonov. An autonomous debating system. Nature, 591(7850):379-384, Mar. 18 2021.
[54] I. R. Humphreys, J. Pei, M. Baek, A. Krishnakumar, I. Anishchenko, S. Ovchinnikov, J. Zhang, T. J. Ness, S. Banjade, S. R. Bagde, V. G. Stancheva, X. H. Li, K. Liu, Z. Zheng, D. J. Barrero, U. Roy, J. Kuper, I. S. Fernandez, B. Szakal, D. Branzei, J. Rizo, C. Kisker, E. C. Greene, S. Biggins, S. Keeney, E. A. Miller, J. C. Fromme, T. L. Hendrickson, Q. Cong, and D. Baker. Computed structures of core eukaryotic protein complexes. Science, 374(6573):1340, 2021.
[55] D. J. Felleman and D. C. Van Essen. Distributed hierarchical processing in the primate cerebral cortex. Cerebral Cortex, 1:1-47, 1991.
[56] X. Wu and J. Weng. Muscle vectors as temporally “Dense Labels”. In Proc. International Joint Conference on Neural Networks, pages 1-8, Glasgow, UK, Jul. 19-24 2020.
[57] T. Cukur, S. Nishimoto, A. G Huth, and J. L. Gallant. Attention during natural vision warps semantic representation across the human brain. Nature Neuroscience, 16:763-770, 2013.
[58] T. N. Wiesel and D. H. Hubel. Ordered arrangement of orientation columns in monkeys lacking visual experience. Journal of Comparative Neurology, 158:307-318, 1974.
[59] K. Fukushima, S. Miyake, and T. Ito. Neocognitron: A neural network model for a mechanism of visual pattern recognition. IEEE Trans. Systems, Man and Cybernetics, 13(5):826-834, 1983.
[60] J. Weng, N. Ahuja, and T. S. Huang. Learning recognition and segmentation using the Cresceptron. International Journal of Computer Vision, 25(2):109-143, November 1997.
[61] J. Sharma, A. Angelucci, and M. Sur. Induction of visual orientation modules in auditory cortex. Nature, 404:841-847, 2000.
[62] J. Weng, Z. Zheng, and X. Wu. Developmental Network Two, its optimality, and emergent Turing machines. U.S. patent application Ser. No. 16/265,212, Feb. 1 2019. Approval pending.
[63] Z. Zheng, X. Wu, and J. Weng. Emergent neural turing macine and its visual navigation. Neural Networks, 110:116-130, 2019.
[64] J. L. Elman. Learning and development in neural networks: The importance of starting small. Cognition, 48(1):71-99, 1993.
[65] A. Hussein, M. M. Gaber, E. Elyan, and C. Jayne. Imitation learning: A survey of learning methods. ACM Computing Surveys, 50:1-35, June 2017.
[66] R. Wang, J. Wang, J. Y. Zhang, X. Y. Xie, Y. X. Yang, S. H. Luo, C. Yu, and W. Li. Perceptual learning at a conceptual level. J. Neuroscience, 36(7):2238-2246, 2016.
[67] M. B. Feller, D. P. Wellis, D. Stellwagen, F. S. Werblin, and C. J. Shatz. Requirement for cholinergic synaptic transmission in the propagation of spontaneous retinal waves. Science, 272(5265):1182-1187, 1996.
[68] E. H. Hess. Imprinting: Early Experience and the Developmental Psychobiology of Attachment. Van Nostrand Reinhold Company, New York, 1973.
[69] A. N. Meltzoff and M. K. Moore. Imitation of facial and manual gestures by human neonates. Science, 198(4312):74-78, Oct. 7 1977.
[70] J. Weng. Conscious intelligence requires developmental autonomous programming for general purposes. In Proc. IEEE Int. Conf on Dev. Learning and Epigenetic Robotics, pages 1-7, Valparaiso, Chile, Oct. 26-27 2020.
[71] S. Harnad. The symbol grounding problem. Physica D, 42:335-346, 1990.
[72] S. Russell and P. Norvig. Artificial Intelligence: A Modern Approach. Prentice-Hall, Upper Saddle River, New Jersey, 3rd edition, 2010.
[73] G. Bi and M. Poo. Synaptic modification by correlated activity: Hebb's postulate revisited. Annual Review of Neuroscience, 24:139-166, 2001.
[74] P. J. Werbos. The Roots of Backpropagation: From Ordered Derivatives to Neural Networks and Political Forecasting. Wiley, Chichester, 1994.
[75] C. Watkins and P. Dayan. Q-learning. Machine Learning, 8:279-292, 1992.
[76] J. Moran and R. Desimone. Selective attention gates visual processing in the extrastrate cortex. Science, 229(4715):782-784, 1985.
[77] A. Graves, G. Wayne, and I. Danihelka. Neural Turing machines. Technical Report arXiv:1410.5401, Google DeepMind, London, UK, Dec. 10, 2014.
[78] A. Graves, G. Wayne, M. Reynolds, T. Harley, I. Danihelka, A. Grabska-Barwinska, S. G. Colmenarejo, E. Grefenstette, T. Ramalho, J. Agapiou, A. P. Badia, K. M. Hermann, Y. Zwols, G. Ostrovski, A. C., H. King, C. Summerfield, P. Blunsom, K. Kavukcuoglu, and D. Hassabis. Hybrid computing using a neural network with dynamic external memory. Nature, 538:471-476, 2016.
[79] Y. LeCun, L. Bottou, Y. Bengio, and P. Haffner. Gradient-based learning applied to document recognition. Proceedings of IEEE, 86(11):2278-2324, 1998.
[80] T. Serre, L. Wolf, S. Bileschi, M. Riesenhuber, and T. Poggio. Robust object recognition with cortex-like mechanisms. IEEE Trans. Pattern Analysis and Machine Intelligence, 29(3):411-426, 2007.
[81] S. Hochreiter and J. Schmidhuber. Long short-term memory. Neural Computation, 9(8):1735-1780, 1997.
[82] S. Warnat-Herresthal, H. Schultze, K. L. Shastry, S. Manamohan, S. Mukherjee, V. Garg, R. Sarveswara, K. Handler, P. Pickkers, N. A. Aziz, S. Ktena, F. Tran, M. Bitzer, S. Ossowski, N. Casadei, C. Herr, D. Petersheim, U. Behrends, F. Kern, T. Fehlmann, P. Schommers, C. Lehmann, M. Augustin, J. Rybniker, J. Altmuller, N. Mishra, J. P. Bernardes, B. Kramer, L. Bonaguro, J. Schulte-Schrepping, E. De Domenico, C. Siever, M. Kraut, M. Desai, B. Monnet, M. Saridaki, C. M. Siegel, A. Drews, M. Nuesch-Germano, H. Theis, J. Heyckendorf, S. Schreiber, S. Kim-Hellmuth, COVID-19 Aachen Study (COVAS), J. Nattermann, D. Skowasch, I. Kurth, A. Keller, R. Bals, P. Nurnberg, O. Rieb, P. Rosenstiel, M. G. Netea, F. Theis, S. Mukherjee, M. Backes, A. C. Aschenbrenner, a T. Ulas, D. COVID-19 Omics Initiative (DeCOI), M. M. B. Breteler, E. J. Giamarellos-Bourboulis, M. Kox, M. Becker, S. Cheran, M. S. Woodacre, E. L. Goh, and J. L. Schultze. Swarm learning for decentralized and confidential clinical machine learning. Nature, 594(7862):265-270, 2021.
[83] A. M. Turing. On computable numbers with an application to the Entscheidungsproblem. Proc. London Math. Soc., 2nd series, 42:230-265, 1936. A correction, ibid., 43, 544-546.
[84] J. E. Hopcroft, R. Motwani, and J. D. Ullman. Introduction to Automata Theory, Languages, and Computation. Addison-Wesley, Boston, M A, 2006.
[85] J. C. Martin. Introduction to Languages and the Theory of Computation. McGraw Hill, Boston, MA, 3rd edition, 2003.
[86] J. L. McClelland. The interaction of nature and nurture in development: A parallel distributed processing perspective. In P. Bertelson, P. Eelen, and G. d'Ydewalle, editors, International Perspectives on Psychological Science, volume 1: Leading Themes, pages 57-88. Erlbaum, Hillsdale, New Jersey, 1994.
[87] J. L. McClelland, D. E. Rumelhart, and The PDP Research Group, editors. Parallel Distributed Processing, volume 2. MIT Press, Cambridge, Massachusetts, 1986.
[88] J. Schmidhuber. Deep learning in neural networks: An overview. Neural Networks, 61:85-117, 2015.
[89] J. K. Tsotsos, S. M. Culhane, W. Y. K. Wai, Y. Lai, N. Davis, and F. Nuflo. Modeling visual attention via selective tuning. Artificial Intelligence, 78:507-545, 1995.
[90] E. M. Izhikevich. Dynamical Systems in Neuroscience. MIT Press, Cambridge, Massachusetts, 2007.
[91] J. Weng. Natural and Artificial Intelligence: Introduction to Computational Brain-Mind. BMI Press, Okemos, Michigan, second edition, 2019.
[92] Y. Wang, X. Wu, and J. Weng. Synapse maintenance in the where-what network. In Proc. Int'l Joint Conference on Neural Networks, pages 2823-2829, San Jose, CA, Jul. 31-Aug. 5, 2011.
[93] D. Wang, Y. Duan, and J. Weng. Motivated optimal developmental leaning for sequential tasks without using rigid time-discounts. IEEE Transactions on Neural Networks and Learning Systems, 29:164-175, 2018.
[94] D. Hebb. The Organization of Behavior. Wiley, New York, 1949.
[95] A. J. Yu and P. Dayan. Uncertainty, neuromodulation, and attention. Neuron, 46:681-692, 2005.
[96] C. Mead and L. Conway. Introduction to VLSI Systems. Addison-Wesley, New York, 1979.
[97] A. Mirhoseini, A. Goldie, M. Yazgan, J. W. Jiang, E. Songhori, S. Wang, Y.-J. Lee, E. Johnson, O. Pathak, A. Nazi, J. Pak, A. Tong, K. Srinivasa, W. Hang, E. Tuncer, Q. V. Lel, J. Laudon, R. Ho, R. Carpenter, and J. Dean. A graph placement methodology for fast chip design. Nature, 594(7862):207-212, 2021.
[98] C. Koch and J. L. Davis, editors. Large-Scale Neuronal Theories of the Brain. MIT Press, Cambridge, M A, 1994.
[99] C. Eliasmith, T. C. Stewart, X. Choo, T. Bekolay, T. DeWolf, Y. Tang, and D. Rasmussen. A large-scale model of the functioning brain. Science, 338:1202-1205, 2012.
[100] G. Rizzolattil and L. Craighero. The mirror-neuron system. Annual Review of Neuroscience, 27:169-192, 2004.
[101] L. S. Vygotsky. Thought and language. MIT Press, Cambridge, Massachussetts, 1962. trans. E. Hanfmann & G. Vakar.
[102] M. Tomasello. The role of joint attentional processes in early language development. Language Sciences, 10:69-88, 1988.
[103] S. Pinker. The Language Instinct: How the Mind Creates Language. William Morrow, New York, 1994.
[104] M. Tomasello. Constructing a Language: A Usage-Based Theory of Language Acquisition. Harvard University Press, Cambridge, MA, 2003.

### ACKNOWLEDGEMENTS

1) Earlier versions of this invention were confidentially submitted for feedbacks since Dec. 25, 2021.
2) The inventor would like to thank Zejia Zheng who developed DN for vision, Xiang Wu who developed DN for audition and planning, and Carstro-Garcia who developed DN for natural languages and generated FIG. 2. Thanks also go to Sam Church, Yu Cong, Peixin He, Jacob Honer, John A. Knoll, Mu-Ming Poo, Lixin Tang, Lide Wu, Xiang Wu, Ming Xie and Jin Xu who have read earlier versions of the manuscript and provided valuable comments that improved the presentation. Cong Yu commented that the priming in [10] is not important, which is consistent to our model.
3) Competing Interests: The inventor declares that they have no competing financial interests. This work has received no funding.

What is claimed is:

1) A neural network which has three types of areas, one or more sensory areas, one or more hidden areas, and one or more motor areas, wherein
a hidden area is connected from a sensory area type or from a motor area type or from both types, a hidden area is connected to a sensory area type or to a motor area type or to both types, and at least one of the three areas grows from a single neuron to a plurality of neurons while the network updates across time.

2) The neural network of claim 1 which recursively maps from a triplelet context of sensory, hidden, and motor at each previous time instant to a triplelet context of sensor, hidden and motor to each current time instant and, therefore, is capable of learning any finite, emergent (vector-input), and incrementally taught Turing machine error-free.

3) The neural network of claim 1 which has
a number of pixels (receptors) wherein the pixels are not spatially uniform to emulate a biological retina or another biological sensor, or
a number of motor neurons (muscles) wherein the motor neurons are not spatially uniform to emulate biological muscles or another biological effector.

4) The neural network of claim 1 which has at least one of following properties represented by two acronyms SACUT GENISAMA: Single brain cells to start, All lives reported, Contexts as motor-hidden-receptor triplelets, Unsupervised, Turing machines, Grounded, Emergent brain areas, Natural, Incremental, Skull-closed, Attentive, Motivated, Abstractive.

5) The neural network of claim 1 wherein the hidden area generates a hierarchy of features wherein features are concrete or local near a censor and are abstract or global near a motor.

6) The neural network of claim 1 which contains multiple glial cells and wherein each neuron has a 3D location and the 3D locations of generated neurons change according to the pulling by nearby glial cells to emulate brain patterning.

7) The neural network of claim 1 goes through a prenatal development using motor-imposed training to model biological development of innate behaviors.

8) The neural network of claim 1 which is free from world-symbols in some areas in the network, including motor areas, to enable motors to learn any world-consciousness at different levels of consciousness in a natural language that is spoken, written, or signed.

9) The neural network of claim 1 wherein usage-based neuronal mitosis enables automatic recruitment of neuronal resources based on a competition and wherein a nerve growth factor simulates growth scheduling over time.

10) The neural network of claim 1 wherein the network is free from motor-imposed training after birth so that postnatal learning is unsupervised or reinforcement or both.

11) The neural network of claim 1 wherein an emergence of firing patterns in the motor area (or premotor area—inside the hidden area and near the motor area) represents a larger and higher context as consciousness.

12) The neural network of claim 1 wherein an on-the-fly consciousness learning process facilitates an acquisition of intelligence.

13) The neural network of claim 1 wherein an autonomous imitation process is a general-purpose mechanism for both learning consciousness and acquiring intelligence.

14) The neural network of claim 1 wherein motor neurons automatically direct an attention on sensors.

15) The neural network of claim 1 wherein an on-the-fly conscious learning process avoids static data sets.

16) The neural network of claim 1 wherein sensors are calibrated by the network autonomously through trial and error.

17) The neural network of claim 1 wherein a redundant or nonredundant limb (or effector) is calibrated by the network autonomously through trial and error.

18) The neural network of claim 1 wherein the network does not have a “central government” like controller such as convolution.

19) The neural network of claim 1 which solves at least one of following 20 “million-dollar” problems: an image annotation problem, a sensorimotor recurrence problem, a motor-supervision problem, a sensor calibration problem, an inverse kinematics problem, a government-free problem, a closed-skull problem, a nonlinear controller problem, a curse of dimensionality problem, an under-sample problem, a distributed vs. local representations problem, a symbol problem or a frame problem, a local minima problem, an abstraction problem, a compositionality problem, a smooth representations problem, a motivation problem, an optimality problem, an auto-programming for general purposes (APFGP) problem, a brain-thinking problem.

20) A neural network comprising of neurons wherein a directional connection from a presynaptic (positive or negative) neuron to a postsynaptic (positive or negative) neuron is based on a probability of firing by the presynaptic neuron conditioned on the post-synaptic neuron and wherein a Hebbian learning or a synaptic maintenance or both result in a threshold value on the probability so that if the corresponding probability is lower than the threshold the connection is absent or cut.
